(19) United States
(12) Patent Application Publication
(10) Pub. No.: US 2015/0084895 A1
(43) Pub. Date: Mar. 26, 2015

(54) LOAD DRIVING METHOD, LOAD DRIVING CIRCUIT, AND APPLICATION DEVICES THEREOF

(71) Applicant: Fairchild Semiconductor Corporation, San Jose, CA (US)

(72) Inventors: Lei HUANG, Beijing (CN); Na MENG, Beijing (CN); ZhaoHong LI, Beijing (CN)

(73) Assignee: Fairchild Semiconductor Corporation, San Jose, CA (US)

(21) Appl. No.: 14/488,095

(22) Filed: Sep. 16, 2014

(30) Foreign Application Priority Data
Sep. 25, 2013 (CN) 201310455850.6

(51) Int. Cl. G05F 1/56; G06F 3/041; H02P 25/02

(52) U.S. Cl. CPC G05F 1/56; H02P 25/027; G06F 3/0416
USPC 345/173; 318/114; 323/273; 323/281

(57) ABSTRACT

The present invention discloses a load driving circuit, comprising a voltage differential generation circuit and a common mode voltage generation circuit; wherein the voltage differential generation circuit is configured to generate a driving voltage for driving a load; and the common mode voltage generation circuit is configured to: when the voltage differential generation circuit generates the driving voltage for driving the load, regulate the voltages output by a first output terminal and a second output terminal of the voltage differential generation circuit to the same voltage value. The present invention also provides a load driving method and application devices thereof. With the technical solutions according to the present invention, a central value of a voltage output by the first output terminal and a voltage output by the second output terminal of the voltage differential generation circuit is effectively regulated. In this way, when a duty cycle of an input signal is within a range of 0 to 100%, the driving voltage generated by the voltage differential generation circuit is in a linear relation with the duty cycle of the input signal, thereby ensuring fidelity of an output signal.

### TECHNICAL FIELD

The present invention relates to the driving technologies, and in particular, to a load driving method, a load driving circuit, and application devices thereof.

### BACKGROUND

At present, network communication technologies and multimedia technologies have created a colorful virtual world of rich visual and audile experience, which bring great joy to people while transmitting information. With high-speed development of the network towards bandwidth, transmission and rendering of haptic information has become a next target in the virtual reality technology, and is drawing attention of the science and technology field, industry field, and commerce field in the world. The haptic rendering technology, as a next generation virtual reality technology, has become a hotspot which is being researched and developed worldwide. The haptic rendering technology refers to: by controlling a physical effect prompt of a haptic display, generating a corresponding touch feeling when a finger touches the display, thereby implementing human-machine interaction with respect to haptic information.

As touch screens gradually replace mechanical keys in handheld consumer devices, due to lack of haptic responses, consumers are imposing requirements on timely responses. Adding the haptic response in the consumer devices may improve user experience. In addition, a haptic function may be designed and provided on the user interface, which is a new mainstream user interface for smartphones and other handheld consumer devices.

In an electronic haptic response system, a motor driving circuit is an essential component. A corresponding motor driving circuit needs to be designed according to the working voltage of the motor. When a single-terminal input motor driving circuit is employed, due to defects of an amplifier component in a voltage differential generation circuit for generating a driving voltage in the motor driving circuit, the generated driving voltage may be subjected to linear distortion. As a result, the driving voltage generated by the voltage differential generation circuit fails to be regulated to a desired voltage by regulating a duty cycle of an input signal. To be specific, a voltage applied on the motor fails to be effectively regulated to the working voltage of the motor.

### SUMMARY

To solve the technical problem in the prior art, embodiments of the present invention provide a load driving method, a load driving circuit, and application devices thereof.

The technical solutions of the present invention are implemented as follows:

An embodiment of the present invention provides a load driving circuit, comprising a voltage differential generation circuit and a common mode voltage generation circuit; wherein:

the voltage differential generation circuit is configured to generate a driving voltage for driving a load; and

the common mode voltage generation circuit is configured to: when the voltage differential generation circuit generates the driving voltage for driving the load, regulate voltages output by a first output terminal and a second output terminal of the voltage differential generation circuit by the same voltage value.

An embodiment of the present invention provides a load driving method. The load driving method comprises:

when a voltage differential generation circuit generates a driving voltage for driving a load, regulating voltages output by a first output terminal and a second output terminal of the voltage differential generation circuit by the same voltage value.

An embodiment of the present invention provides a touch apparatus, comprising a touch screen and a load driving circuit, wherein the load driving circuit comprises a voltage differential generation circuit and a common mode voltage generation circuit; wherein:

the voltage differential generation circuit is configured to generate a driving voltage for driving a load; and

the common mode voltage generation circuit is configured to: when the voltage differential generation circuit generates the driving voltage for driving the load, regulate voltages at a first output terminal and a second output terminal of the voltage differential generation circuit by the same voltage value.

An embodiment of the present invention provides an electronic device, comprising: a main board, a housing, and a touch apparatus, the touch apparatus comprising a touch screen and a load driving circuit, wherein the load driving circuit comprises a voltage differential generation circuit and a common mode voltage generation circuit; wherein:

the voltage differential generation circuit is configured to generate a driving voltage for driving a load; and

the common mode voltage generation circuit is configured to: when the voltage differential generation circuit generates the driving voltage for driving the load, regulate voltages at a first output terminal and a second output terminal of the voltage differential generation circuit by the same voltage value.

According to the load driving method, the load driving circuit, and application devices thereof provided in the embodiments of the present invention, when the voltage differential generation circuit generates a driving voltage for driving a load, the common mode voltage generation circuit regulates voltages output by a first output terminal and a second output terminal of the voltage differential generation circuit by the same voltage value, such that a central value of a voltage output by the first output terminal and a voltage output by the second output terminal of the voltage differential generation circuit is effectively regulated. In this way, when a duty cycle of an input signal is within a range of 0 to 100%, the driving voltage generated by the voltage differential generation circuit is in a linear relation with the duty cycle of the input signal, thereby ensuring fidelity of an output signal.

In addition, the implementation solutions according to the embodiments of the present invention are simple, convenient, and easy to implement.

### BRIEF DESCRIPTION OF DRAWINGS

FIG. 1 is a schematic structural diagram of output stages of two amplifiers in a voltage differential generation circuit;

FIG. 2A is a schematic structural diagram of a simulation result obtained by simulation using a conventional load driving circuit;

FIG. 2B is a schematic structural diagram of a product test result after an integrated circuit is fabricated using the conventional load driving circuit;

FIG. 3 is a schematic structural diagram of a load driving circuit according to an embodiment of the present invention;

FIG. 4A is a schematic structural diagram of a load driving circuit according to Embodiment 1 of the present invention;

FIG. 4B is a schematic structural diagram of another load driving circuit according to Embodiment 1 of the present invention;

FIG. 5 is a schematic structural diagram of a load driving circuit according to Embodiment 2 of the present invention;

FIG. 6 is a schematic view of a simulation result obtained by simulation using a load driving circuit according to an embodiment of the present invention; and

FIG. 7 is a schematic view of a product test result after an integrated circuit is fabricated using a load driving circuit according to an embodiment of the present invention.

### DETAILED DESCRIPTION

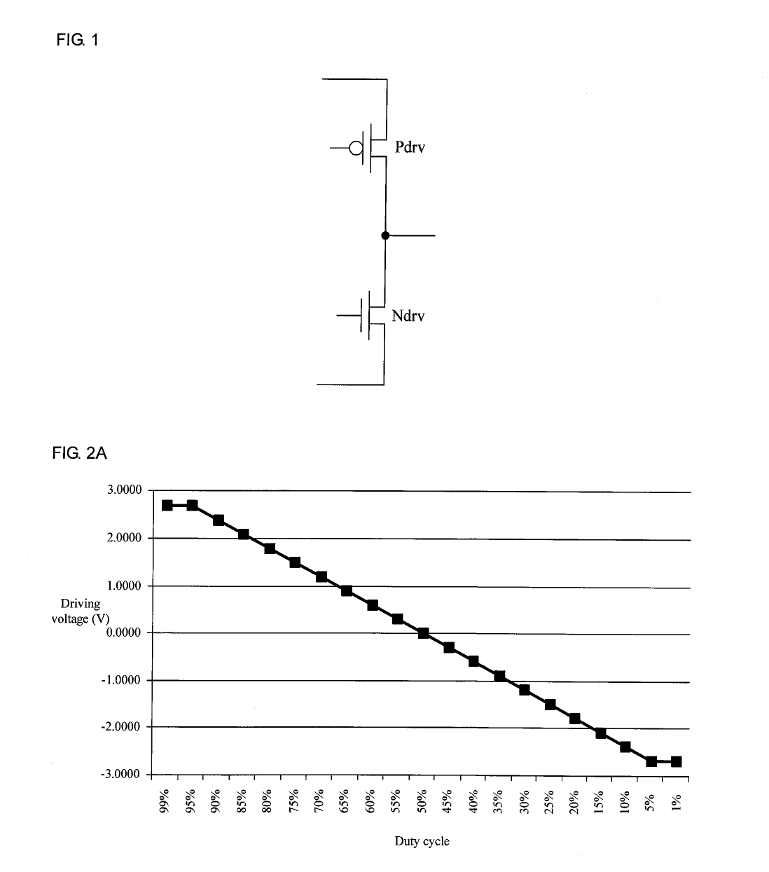

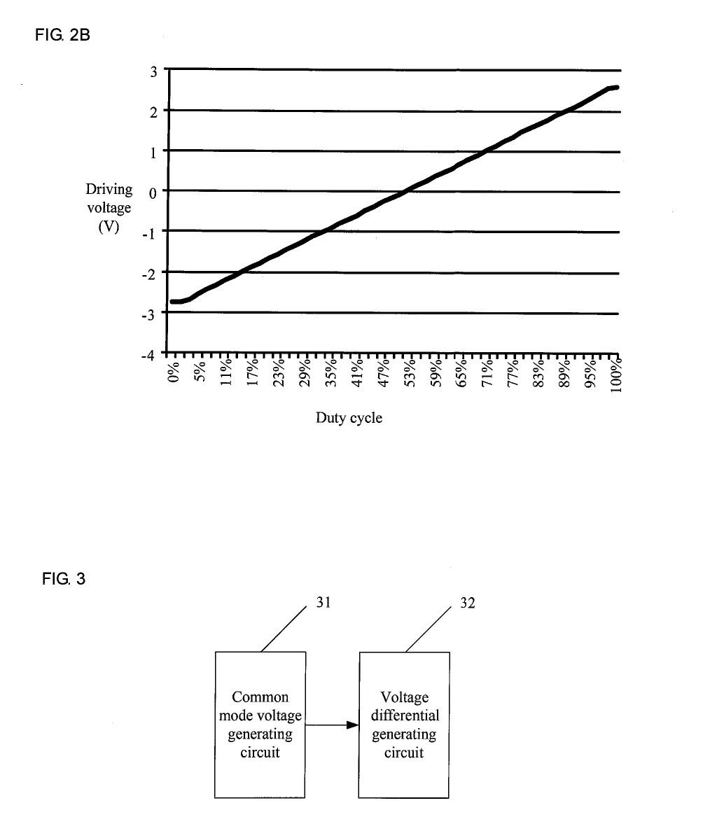

At present, in the single-terminal input motor driving circuit designed according to the working voltage of the motor specified on the motor before delivery from factory, since two amplifier components in the voltage differential generation circuit for generating the driving voltage in the motor driving circuit are subjected to defects, that is, a metal-oxide-semiconductor field-effect transistor (MOSFET) as an output stage of the amplifier is in a deep linear region, the generated driving voltage may be subjected to linear distortion. As a result, when the driving voltage generated by the voltage differential generation circuit is regulated by regulating the duty cycle of the input signal, the driving voltage generated by the voltage differential generation circuit fails to be regulated to a desired voltage. To be specific, the voltage applied on the motor fails to be effectively regulated to the working voltage of the motor. For example, FIG. 1 illustrates output states of two amplifiers in a voltage differential generation circuit. Assume that the working voltage of the motor is V_{reg}, when the desired driving voltage is V_{reg}, one output terminal of the voltage differential generation circuit needs to output a voltage V_{reg}, and the other output terminal of the voltage differential generation circuit needs to output a voltage 0. However, since the MOSFET as an output stage of the amplifier is in a deep linear region, the voltage output by the other output terminal of the voltage differential generation circuit is not 0, but is a value greater than 0, such that the driving voltage generated by the voltage differential generation circuit is not V_{reg}, but is a voltage less than V_{reg}. In this way, when the duty cycle of the input signal is with a range of 0 to 100%, as illustrated in FIG. 2A and FIG. 2B, the driving voltage generated by the voltage differential generation circuit is not completely in a linear relation with the duty cycle of the input signal.

The single-terminal input herein refers to that an input voltage in the voltage differential generation circuit is only connected relatively from an input terminal.

Based on this, in the embodiments of the present invention, when the voltage differential generation circuit generates a driving voltage for driving a load, the common mode voltage generation circuit regulates voltages output by a first output terminal and a second output terminal of the voltage differential generation circuit by the same voltage value, such that a central value of a voltage output by the first output terminal and a voltage output by the second output terminal of the voltage differential generation circuit is regulated. In this way, when a duty cycle of an input signal is within a range of 0 to 100%, the driving voltage generated by the voltage differential generation circuit is in a linear relation with the duty cycle of the input signal, thereby ensuring fidelity of an output signal.

The present invention is described hereinafter in detail with reference to the attached drawings and specific embodiments.

An embodiment of the present invention provides a load driving circuit. As illustrated in FIG. 3, the load driving circuit comprises a voltage differential generation circuit 31 and a common mode voltage generation circuit 32; wherein:

When the voltage differential generation circuit 32 generates a driving voltage for driving a load, the common mode voltage generation circuit 31 regulates voltages output by a first output terminal and a second output terminal of the voltage differential generation circuit 32 by the same voltage value, such that a central value of a voltage output by the first output terminal and a voltage output by the second output terminal of the voltage differential generation circuit 32 is regulated by a first voltage. In this way, when a duty cycle of an input signal is within a range of 0 to 100%, the driving voltage generated by the voltage differential generation circuit 32 is in a linear relation with the duty cycle of the input signal, thereby ensuring fidelity of an output signal. The first voltage may be set according to the actual requirements, for example, 50 mV, 100 mV, 150 mV, 200 mV, or the like. Herein, assume that the voltage output by the first output terminal is Vₒᵤₜ₁ and the voltage output by the second output terminal is Vₒᵤₜ₂, then the central value is specifically calculates as:

$$\frac{{V}_{out 1} + {V}_{out 2}}{2} .$$

Regulating a central value of a voltage output by the first output terminal and a voltage output by the second output terminal of the voltage differential generation circuit 32 by a first voltage refers to: using a central value of the voltage output by the first output terminal and the voltage output by the second output terminal when the load driving circuit does not comprise the common mode voltage generation circuit 31 as a reference, up-regulating or down-regulating the central value of the voltage output by the first output terminal and the voltage output by the second output terminal of the voltage differential generation circuit 32 by the first voltage, that is, using the voltage output by the first output terminal and the voltage output by the second output terminal when the load driving circuit does not comprise the common mode voltage generation circuit 31 as a reference, up-regulating or down-regulating the voltage output by the first output terminal and the voltage output by the second output terminal of the voltage differential generation circuit 32 by the same voltage.

In this embodiment, the load driving circuit is a single-terminal input driving circuit. The single-terminal input driving circuit herein refers to that: an input voltage in the voltage differential generation circuit 32 is only connected relatively from an input terminal; simply speaking, the voltage differential generation circuit 32 has only one input voltage.

The load may be a motor, wherein the motor may be a haptic motor, for example, an eccentric rotating mass (ERM) motor, or the like.

### Embodiment 1

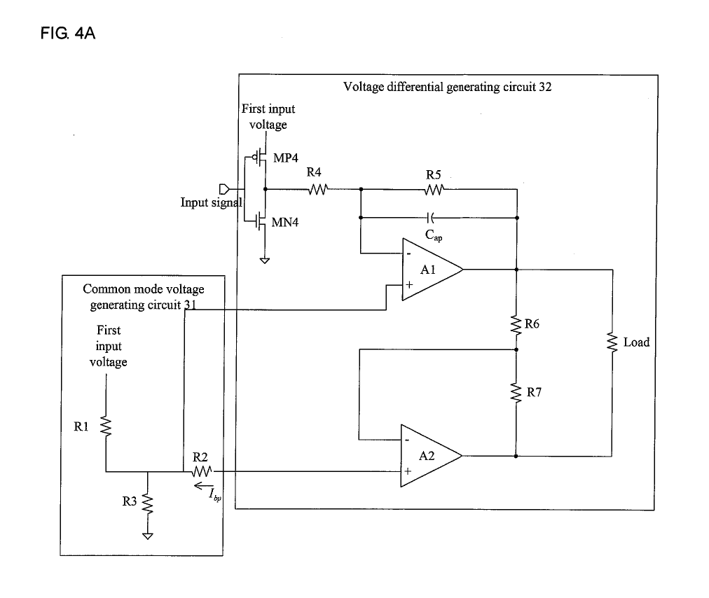

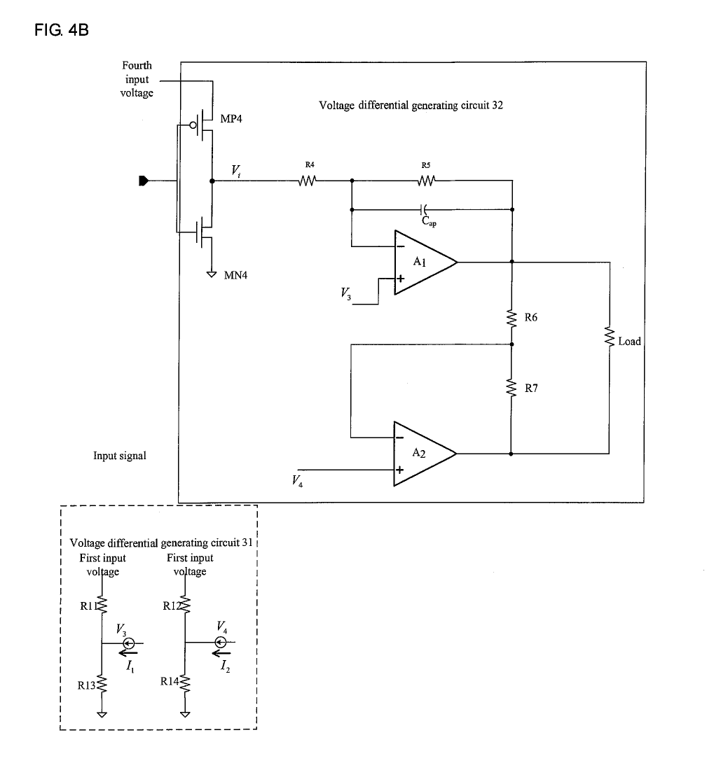

In this embodiment, as illustrated in FIG. 4A, the common mode voltage generation circuit 31 may comprise: a first resistor R1, a second resistor R2, and a third resistor R3; and the voltage differential generation circuit 32 may comprise: a fourth p-channel metal-oxide-semiconductor field-effect transistor (PMOSFET) MP4, a fourth n-channel metal-oxide-semiconductor field-effect transistor (NMOSFET) MN4, a fourth resistor R4, a fifth resistor R5, a sixth resistor R6, a seventh resistor R7, a first operational amplifier A1, a second operational amplifier A2, and a capacitor Cₐₚ.

The connection relations among various components of the load driving circuit as illustrated in FIG. 4A are as follows:

In the common mode voltage generation circuit 31, one terminal of the first resistor R1 is connected to a first input voltage, the other terminal of the first resistor R1 is connected to one terminal of the second resistor R2, one terminal of the third resistor R3 and a positive pole of the first operational amplifier A1 in the voltage differential generation circuit 32, the other terminal of the second resistor R2 is connected to a positive pole of the second operational amplifier A2 in the voltage differential generation circuit 32, the other terminal of the third resistor R3 is grounded, a resistance ratio of the first resistor R1 to the second resistor R2 to the third resistor R3 is R1:R2:R3=2:1:2.

In the voltage differential generation circuit 32, a gate of the fourth PMOSFET MP4 is connected to an input signal and a gate of the fourth NMOSFET MN4, a source of the fourth PMOSFET MP4 is connected to the first input voltage, a drain of the fourth PMOSFET MP4 is connected to one terminal of the fourth resistor R4 and a drain of the fourth NMOSFET MN4, a source of the fourth NMOSFET MN4 is grounded, the other terminal of the fourth resistor R4 is connected to one terminal of the fifth resistor R5, one terminal of the capacitor Cₐₚ and a negative pole of the first operational amplifier A1, the other terminal of the fifth resistor R5 is connected to the other terminal of the capacitor Cₐₚ, an output terminal of the first operational amplifier A1 and one terminal of the sixth resistor R6, the other terminal of the sixth resistor R6 is connected to a negative pole of the second operational amplifier A2 and one terminal of the seventh resistor R7, the other terminal of the seventh resistor R7 is connected to an output terminal of the second operational amplifier A2, the output terminal of the first operational amplifier A1 and the output terminal of the second operational amplifier A2 are respectively connected to two terminals of the load, a resistance ratio of the fifth resistor R5 to the fourth resistor R4 is 1:1, and a resistance of the sixth resistor R6 is equal to that of the seventh resistor R7.

The input signal herein may be a pulse signal, for example, a pulse width modulation (PWM) signal. The value of the first input voltage may be determined according to related working parameters of the load. For example, assume that the load is a motor, the value of the first input voltage may be determined according to the working voltage of the motor. For example, if the working voltage of the motor is 3 V, the first input voltage is 3 V. Herein, the working voltage of the motor may be determined according to the working voltage set for the motor before delivery from factory. For example, if the working voltage set for the motor before delivery from factory is 3 V, it is determined that the working voltage of the motor is 3 V. After the value of the first input voltage is determined, the first input voltage may be provided by a power supply capable of generating a constant alternate current voltage, for example, a voltage regulator or the like, for use by corresponding components in the load driving circuit, such that the load driving circuit generates a corresponding driving voltage. The regulator may be specifically a low dropout (LDO) regulator or the like. The first operational amplifier and the second operational amplifier may be both class-AB amplifiers. In this way, when the amplifier works, a great current may be output such that requirements of the circuit are accommodated.

For ease of description, in the description of the working principles of the load driving circuit as illustrated in FIG. 4A, the output terminal of the first operational amplifier A1 is referred to as a first output terminal of the voltage differential generation circuit 32, and the output terminal of the second operational amplifier A2 is referred to as a second output terminal of the voltage differential generation circuit 32; the voltage connected to the positive pole of the first operational amplifier A1 is referred to as V_{cmi}, and the voltage connected to the positive pole of the second operational amplifier A2 is referred to as V_{cmo}, the first input voltage is referred to as V_{reg}, the voltage output by the first output terminal is referred to as Vₒᵤₜ₁, and the voltage output by the second output terminal is referred to as Vₒᵤₜ₂.

The working principles of the load driving circuit as illustrated in the FIG. 4A are as follows:

When the load driving circuit works, a current I_{bp} is applied to the second resistor R2, and a flow direction of the current I_{bp} is from the second resistor R2 to the third resistor R3. Assume that the resistance of the first resistor R1 is 2R, then the resistance of the second resistor R2 is R, and the resistance of the third resistor R3 is 2R. In this case, a reference voltage of the first operational amplifier A1, that is, the voltage connected to the positive pole of the first operational amplifier A1 is

$${V}_{cmi} = \frac{{V}_{reg}}{2} + {I}_{bp} \times R ,$$

and correspondingly, a reference voltage of the second operational amplifier A2, that is, the voltage connected to the positive pole of the second operational amplifier A2 is

$${V}_{cmo} = \frac{{V}_{reg}}{2} + {I}_{bp} \times 2 R .$$

Under such circumstances, when the input signal is a low-level signal, the fourth PMOSFET MP4 is conducted and the fourth NMOSFET MN4 is turned off, such that the voltage of the input signal is V_{reg}. Since the reference voltage of the first operational amplifier A1 is

$${V}_{cmi} = \frac{{V}_{reg}}{2} + {I}_{bp} \times R$$

and the reference voltage of the second operational amplifier A2 is

$${V}_{cmo} = \frac{{V}_{reg}}{2} + {I}_{bp} \times 2 R ,$$

the voltage output by the first output terminal of the voltage differential generation circuit 32 is Vₒᵤₜ₁=V_{reg}+2R×I_{bp} and correspondingly the voltage output by the second output terminal of the voltage differential generation circuit 32 is Vₒᵤₜ₂=2R×I_{bp}, such that the driving voltage generated by the voltage differential generation circuit 32 is V_{driver}=Vₒᵤₜ₂−Vₒᵤₜ₁=−V_{reg}. Analogously, when the input signal is a high-level signal, the fourth PMOSFET MP4 is turned off and the fourth NMOSFET MN4 is conducted, such that the voltage of the input signal is 0. Since the reference voltage of the first operational amplifier A1 is

$${V}_{cmi} = \frac{{V}_{reg}}{2} + {I}_{bp} \times R$$

and the reference voltage of the second operational amplifier A2 is

$${V}_{cmo} = \frac{{V}_{reg}}{2} + {I}_{bp} \times 2 R ,$$

the voltage output by the first output terminal of the voltage differential generation circuit 32 is Vₒᵤₜ₁=R×2I_{bp} and correspondingly the voltage output by the second output terminal of the voltage differential generation circuit 32 is Vₒᵤₜ₂=V_{reg}+R×2I_{bp}, such that the driving voltage generated by the voltage differential generation circuit 32 is V_{driver}=Vₒᵤₜ₂−Vₒᵤₜ₁=V_{reg}.

In conclusion, the reference voltages of the first operational amplifier A1 and the second operational amplifier A2 are regulated such that a central value of the voltage output by the first output terminal and the voltage output by the second output terminal of the voltage differential generation circuit 32 is up-regulated, that is, up-regulated from

$$\frac{{V}_{reg}}{2} to \frac{{V}_{reg}}{2} + {I}_{bp} \times 2 R .$$

To be specific, the central value of the voltage output by the first output terminal and the voltage output by the second output terminal of the voltage differential generation circuit 32 is up-regulated by I_{bp}×2R , that is, the first voltage is I_{bp}×2R.

When the input signal is a low-level signal, the duty cycle of the input signal is 0; and when the input signal is a high-level signal, the duty cycle of the input signal is 100%. The current I_{bp} applied on the second resistor R2 may be generated by an additional circuit.

The principles of down-regulating the central value of the voltage output by the first output terminal and the voltage output by the second output terminal in the voltage differential generation circuit 32 are the same as those of up-regulating the central value of the voltage output by the first output terminal and the voltage output by the second output terminal in the voltage differential generation circuit 32.

Based on FIG. 4A, when the voltage differential generation circuit is subjected to an N-fold gain, that is, a resistance ratio of the fifth resistor R5 and the fourth resistor R4 is N:1, in another load driving circuit according to this embodiment, as illustrated in FIG. 4B, the common mode voltage generation circuit 31 may comprise: an eleventh resistor R11, a twelfth resistor R12, a thirteenth resistor R13, and a fourteenth resistor R14; and the voltage differential generation circuit 32 may comprise: a fourth PMOSFET MP4, a fourth NMOSFET MN4, a fourth resistor R4, a fifth resistor R5, a sixth resistor R6, a seventh resistor R7, a first operational amplifier A1, a second operational amplifier A2, and a capacitor Cₐₚ.

The connection relations among various components of the load driving circuit as illustrated in FIG. 4B are as follows:

In the common mode voltage generation circuit 31, one terminal of the eleventh resistor R11 is connected to the first input voltage and the other terminal of the eleventh resistor R11 is connected to one terminal of the thirteenth resistor R13 and a positive pole of the first operational amplifier A1 in the voltage differential generation circuit 32, one terminal of the twelfth resistor R12 is connected to the first input voltage and the other terminal of the twelfth resistor R12 is connected to one terminal of the fourteenth resistor R14 and a positive pole of the second operational amplifier A2 in the voltage differential generation circuit 32, the other terminal of the thirteenth resistor R13 and the other terminal of the fourteenth resistor R14 are both grounded, a resistance ratio of the eleventh resistor R11 to the thirteenth resistor R13 is N:1, and a resistance ratio of the twelfth resistor R12 to the fourteenth resistor R14 is 1:1.

In the voltage differential generation circuit 32, a gate of the fourth PMOSFET MP4 is connected to an input signal and a gate of the fourth NMOSFET MN4, a source of the fourth PMOSFET MP4 is connected to a fourth input voltage, a drain of the fourth PMOSFET MP4 is connected to one terminal of the fourth resistor R4 and a drain of the fourth NMOSFET MN4, a source of the fourth NMOSFET MN4 is grounded, the other terminal of the fourth resistor R4 is connected to one terminal of the fifth resistor R5, one terminal of the capacitor Cₐₚ and a negative pole of the first operational amplifier A1, the other terminal of the fifth resistor R5 is connected to the other terminal of the capacitor Cₐₚ, an output terminal of the first operational amplifier A1 and one terminal of the sixth resistor R6, the other terminal of the sixth resistor R6 is connected to a negative pole of the second operational amplifier A2 and one terminal of the seventh resistor R7, the other terminal of the seventh resistor R7 is connected to an output terminal of the second operational amplifier A2, the output terminal of the first operational amplifier A1 and the output terminal of the second operational amplifier A2 are respectively connected to two terminals of the load, a resistance ratio of the fifth resistor R5 to the fourth resistor R4 is 1:1, and a resistance of the sixth resistor R6 is equal to that of the seventh resistor R7. The fourth input voltage is 1/N of the first input voltage.

The working principles of the load driving circuit as illustrated in FIG. 4B are analogous to those of the load driving circuit as illustrated in FIG. 4A. However, it should be noted that when the load driving circuit works, a current I₁ needs to be applied to the eleventh resistor R11, and a direction of the current I₁ is from the positive pole of the first operational amplifier A1 to the eleventh resistor R11; and a current I₂ needs to be applied to the twelfth resistor R12, and a direction of the current I₂ is from the positive pole of the second operational amplifier A2 to the twelfth resistor R12. Assume that the resistance of the thirteenth resistor R13 is R₁₃ and the resistance of the fourteenth resistor R14 is R₁₄, then

$${I}_{1} \times {R}_{13} = \frac{{I}_{2} \times {R}_{14}}{2 N} .$$

As seen from the above description, in the load driving circuit as illustrated in FIG. 4B, the common mode voltage generation circuit 31 regulates the reference voltage of the first operational amplifier in the voltage differential generation circuit 32 from a second voltage to a third voltage, and regulates the reference voltage of the second operational amplifier in the voltage differential generation circuit 32 from the second voltage to a fourth voltage, wherein the third voltage satisfies equation

$${V}_{3} = \frac{{V}_{reg} + {V}_{1}}{N + 1}$$

and the fourth voltage satisfies equation

$${V}_{4} = \frac{{V}_{reg}}{2} + {V}_{1} .$$

In this way, the central value of the voltage output by the first output terminal and the voltage output by the second output terminal of the voltage differential generation circuit 32 are regulated by the first voltage. In the equations, V₃ denotes the third voltage, V_{reg} denotes a first input voltage, V₁ denotes a voltage, i.e., the first voltage, by which voltages output by the first output terminal and the second output terminal of the voltage differential generation circuit 32 are regulated; the first voltage or the second voltage is half of the first input voltage of the voltage differential generation circuit 32; and the first input voltage is a maximum value of the driving voltage that needs to be generated. In this embodiment, the third voltage corresponds to V_{cmi} in the load driving circuit as illustrated in FIG. 4A, the fourth voltage corresponds to V_{cmo} in the load driving circuit as illustrated in FIG. 4A, V₁ corresponds to I_{bp}×2R in the load driving circuit as illustrated in FIG. 4A.

Herein, a central value of the voltage output by the first output terminal and the voltage output by the second output terminal of the voltage differential generation circuit 32 is regulated, such that when a duty cycle of an input signal is within a range of 0 to 100%, the first operational amplifier and the second operational amplifier in the voltage differential generation circuit 32 both work in a linear region, thereby ensuring fidelity of an output signal.

### Embodiment 2

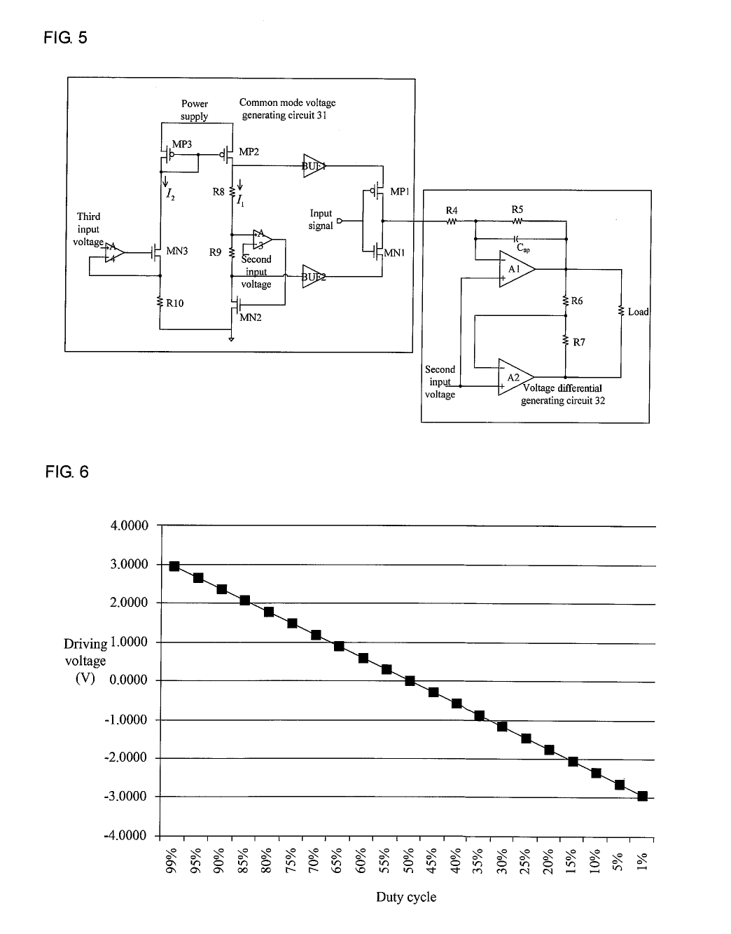

In this embodiment, as illustrated in FIG. 5, the common mode voltage generation circuit 31 may comprise: an eighth resistor R8, a ninth resistor R9, a tenth resistor R10, a first PMOSFET MP1, a second PMOSFET MP2, a third PMOSFET MP3, a first NMOSFET MN1, a second NMOSFET MN2, a third NMOSFET MN3, a third operational amplifier A3, a fourth operational amplifier A4, a first buffer BUF1, and a second buffer BUF2; and the voltage differential generation circuit 32 may comprise: a fourth resistor R4, a fifth resistor R5, a sixth resistor R6, a seventh resistor R7, a first operational amplifier A1, a second operational amplifier A2, and a capacitor Cₐₚ.

The connection relations among various components of the load driving circuit as illustrated in FIG. 5 are as follows:

In the common mode voltage generation circuit 31, a gate of the first PMOSFET MP1 is connected to an input signal, a source of the first PMOSFET MP1 is connected to an output terminal of the first buffer BUF1, a drain of the first PMOSFET MP1 is connected to a drain of the first NMOSFET MN1 and one terminal of the fourth resistor R4 in the voltage differential generation circuit 32, an input terminal of the first buffer BUF1 is connected to a drain of the second PMOSFET MP2 and one terminal of the eighth resistor R8, a gate of the second PMOSFET MP2 is connected to a gate of the third PMOSFET MP3, a drain of the third PMOSFET MP3 and a drain of the third NMOSFET MN3, a source of the second PMOSFET MP2 is connected to a source of the third PMOSFET MP3 and a power supply, a gate of the first NMOSFET MN1 is connected to an input signal, a source of the first NMOSFET MN1 is connected to an output terminal of the second buffer BUF2, an input terminal of the second buffer BUF2 is connected to a drain of the second NMOSFET MN2 and one terminal of the ninth resistor R9, a gate of the second NMOSFET MN2 is connected to an output terminal of a third operational amplifier A3, a source of the second NMOSFET MN2 is connected to one terminal of the tenth resistor R10 and grounded, a positive pole of the third operational amplifier A3 is connected to the other terminal of the eighth resistor R8 and the other terminal of the ninth resistor R9, a negative pole of the third operational amplifier A3 is connected to a second input voltage, the other terminal of the tenth resistor R10 is connected to a source of the third NMOSFET MN3 and a negative pole of a fourth operational amplifier A4, a positive pole of the fourth operational amplifier A4 is connected to a third input voltage, an output terminal of the fourth operational amplifier A4 is connected to a gate of the third NMOSFET MN3, and a resistance of the eighth resistance R8 is equal to that of the ninth resistor R9.

In the voltage differential generation circuit 32, the other terminal of the fourth resistor R4 is connected to one terminal of the fifth resistor R5, one terminal of the capacitor Cₐₚ is connected to a negative pole of the first operational amplifier A1, the other terminal of the fifth resistor R5 is connected to the other terminal of the capacitor Cₐₚ, an output terminal of the first operational amplifier A1 and one terminal of the sixth resistor R6, the other terminal of the sixth resistor R6 is connected to a negative pole of the second operational amplifier A2 and one terminal of the seventh resistor R7, the other terminal of the seventh resistor R7 is connected to an output terminal of the second operational amplifier A2, a positive pole of the first operational amplifier A1 and a positive pole of the second operational amplifier A2 are both connected to a second input voltage, an output terminal of the first operational amplifier A1 and an output terminal of the second operational amplifier A2 are respectively connected to two terminals of the load, and a resistance of the sixth resistor R6 is equal to that of the seventh resistor R7.

The input signal herein may be a pulse signal, for example, a PWM signal. The value of the second input voltage is half of the voltage provided by the power supply. To be specific, a resistor may be serially connected between the power supply and the negative pole of the third operational amplifier A3 and a resistor may be serially connected between the power supply and the positive pole of the first operational amplifier A1 and the positive pole of the second operational amplifier A2, such that the value of the second input voltage is half of the voltage provided by the power supply. The power supply is directed to supply power for the load driving circuit. The value of the third input voltage is half of a reference voltage generated by a reference voltage generation circuit. To be specific, a resistor may be serially connected between the reference voltage generation circuit and the positive pole of the fourth operational amplifier A4, such that the value of the third input voltage is half of a reference voltage generated by a reference voltage generation circuit. The reference voltage generation circuit is directed to providing a bias voltage for the load driving circuit, such that various components in the entire load driving circuit are in a working state anytime. The first operational amplifier and the second operational amplifier are both class-AB amplifiers. In this way, when the amplifier works, a great current may be output such that requirements of the circuit are accommodated.

For ease of description, in the description of the working principles of the load driving circuit as illustrated in FIG. 5, the output terminal of the first operational amplifier Al is referred to as a first output terminal of the voltage differential generation circuit 32, the output terminal of the second operational amplifier A2 is referred to as a second output terminal of the voltage differential generation circuit 32, the voltage output by the first output terminal is referred to as Vₒᵤₜ₁, the voltage output by the second output terminal is referred to as Vₒᵤₜ₂, a current flowing through the eighth resistor R8 and the ninth resistor R9 and flowing along a direction from the eighth resistor R8 to the ninth resistor R9 is referred to as I₁, a current flowing through the tenth resistor R10 and flowing along a direction from the drain of the third PMOSFET MP3 to the tenth resistor R10 is referred to as I₂, the voltage provided by the power supply is referred to as V_{DD}, the reference voltage generated by the reference voltage generation circuit is referred to as V_{bg}, and the working voltage of the load is referred to as V_{reg}. Herein, the value of the working voltage of the load may be determined according to related working parameters of the load. For example, assume that the load is a motor, the value of the first input voltage may be determined according to the working voltage of the motor. For example, if the working voltage of the motor is 3 V, the first input voltage is 3 V. After the value of the first input voltage is determined, the first input voltage may be provided by a power supply capable of generating a constant alternate current voltage, for example, a voltage regulator or the like, for use by corresponding components in the load driving circuit, such that the load driving circuit generates a corresponding driving voltage. The regulator may be specifically an LDO regulator or the like.

The working principles of the load driving circuit as illustrated in the FIG. 5 are as follows:

When the load driving circuit works, when the input signal is a low-level signal, the first PMOSFET MP1 is conducted and the first NMOSFET MN1 is turned off, such that the voltage of the input signal is

$$\frac{{V}_{DD} + {V}_{reg}}{2} .$$

In this case, since the reference voltages of the first operational amplifier A1 and the second operational amplifier A2, i.e., the voltages connected to the positive poles of the first and second operational amplifiers, are both

$$\frac{{V}_{DD}}{2} ,$$

the voltage output by the first output terminal of the voltage differential generation circuit 32 is

$${V}_{out 1} = \frac{{V}_{DD} - {V}_{reg}}{2}$$

and the voltage output by the second output terminal of the voltage differential generation circuit 32 is

$${V}_{out 2} = \frac{{V}_{DD} - {V}_{reg}}{2} ,$$

such that the driving voltage generated by the voltage differential generation circuit 32 is V_{driver}=Vₒᵤₜ₂−Vₒᵤₜ₁=−V_{reg}. Analogously, when the input signal is a high-level signal, the first NMOSFET MN1 is conducted and the first PMOSFET MP1 is turned off, such that the voltage of the input signal is

$$\frac{{V}_{DD} - {V}_{reg}}{2} .$$

In this case, since the reference voltages of the first operational amplifier A1 and the second operational amplifier A2 are both

$$\frac{{V}_{DD}}{2} ,$$

the voltage output by the first output terminal of the voltage differential generation circuit 32 is

$${V}_{out 1} = \frac{{V}_{DD} - {V}_{reg}}{2}$$

and the voltage output by the second output terminal of the voltage differential generation circuit 32 is

$${V}_{out 2} = \frac{{V}_{DD} + {V}_{reg}}{2} ,$$

such that the driving voltage generated by the voltage differential generation circuit 32 is V_{driver}=Vₒᵤₜ₂−Vₒᵤₜ₁=V_{reg}.

In conclusion, a voltage range of the input signal is regulated from a range of 0 to V_{reg} to a range of

$$\frac{{V}_{DD} - {V}_{reg}}{2} to \frac{{V}_{DD} + {V}_{reg}}{2} ,$$

such that a central value of the voltage output by the first output terminal and the voltage output by the second output terminal of the voltage differential generation circuit 32 is up-regulated, that is, up-regulated from

$$\frac{{V}_{reg}}{2}$$

to

$$\frac{{V}_{DD}}{2} .$$

To be specific, the central value of the voltage output by the first output terminal and the voltage output by the second output terminal of the voltage differential generation circuit 32 is up-regulated by

$$\frac{{V}_{DD} - {V}_{reg}}{2} ,$$

that is, the first voltage is

$$\frac{{V}_{DD} - {V}_{reg}}{2} .$$

When the input signal is a low-level signal, the duty cycle of the input signal is 0; and when the input signal is a high-level signal, the duty cycle of the input signal is 100%.

In the load driving circuit as illustrated in FIG. 5, assume that the resistances of the eight resistor R8 and the ninth resistor R9 are both R₁ and the resistance of the tenth resistor R10 is R₂, then the following equation may be given:

$$\begin{matrix}{I}_{1} = \frac{{V}_{ref}}{2 \times {R}_{1}} & ( 1 ) \\ {I}_{2} = \frac{{V}_{bg}}{{R}_{2}} & ( 2 )\end{matrix}$$

### Therefore,

$${V}_{reg} = 2 \times \frac{{R}_{1}}{{R}_{2}} \times {V}_{bg} \times \frac{{I}_{1}}{{I}_{2}} \qquad ( 3 )$$

Since V_{bg} is a fixed value, in practice, when V_{reg} is determined, a ratio of R₁ to R₂ may be obtained according to equation (3), and thus specific values of R₁ and R₂ may be determined.

The principles of down-regulating the central value of the voltage output by the first output terminal and the voltage output by the second output terminal in the voltage differential generation circuit 32 are the same as those of up-regulating the central value of the voltage output by the first output terminal and the voltage output by the second output terminal in the voltage differential generation circuit 32.

As seen from the above description, in the load driving circuit as illustrated in FIG. 5, upon determining a range of the driving voltage to be generated, the common mode voltage generation circuit 31 regulates a voltage range of an input signal based on the range of the driving voltage by a fifth voltage, and regulates reference voltages of a first operational amplifier and a second operational amplifier a sixth voltage to a seventh voltage, wherein: the fifth voltage, the sixth voltage, the seventh voltage satisfy equation V₅=V₇−V₆, where V₅ denotes the fifth voltage, V₆ denotes the sixth voltage, V₇ denotes the seventh voltage, the sixth voltage is half of a maximum value of the driving voltage that needs to be generated, and the fifth voltage is equal to the first voltage. Herein, V₅ corresponds to

$$\frac{{V}_{DD} - {V}_{reg}}{2} ,$$

V₆ corresponds to

$$\frac{{V}_{reg}}{2} ,$$

and V₇ corresponds to

$$\frac{{V}_{DD}}{2} .$$

Herein, a central value of the voltage output by the first output terminal and the voltage output by the second output terminal of the voltage differential generation circuit 32 is regulated, such that when a duty cycle of an input signal is within a range of 0 to 100%, the first operational amplifier and the second operational amplifier in the voltage differential generation circuit 32 both work in a linear region, thereby ensuring fidelity of an output signal.

Based on the above load driving circuit, an embodiment of the present invention provides a load driving method. The load driving method comprises: when the voltage differential generation circuit generates a driving voltage for driving a load, up-regulating voltages output by a first output terminal and a second output terminal of the voltage differential generation circuit by the same voltage value, such that a central value of a voltage output by the first output terminal and a voltage output by the second output terminal of the voltage differential generation circuit is regulated by a first voltage. In this way, when a duty cycle of an input signal is within a range of 0 to 100%, the driving voltage generated by the voltage differential generation circuit is in a linear relation with the duty cycle of the input signal, thereby ensuring fidelity of an output signal. The first voltage may be set according to the actual requirements, for example, 50 mV, 100 mV, 150 mV, 200 mV, or the like. Herein, assume that the voltage output by the first output terminal is Vₒᵤₜ₁ and the voltage output by the second output terminal is Vₒᵤₜ₂, then the central value is specifically calculates as:

$$\frac{{V}_{out 1} + {V}_{out 2}}{2} .$$

Regulating a central value of a voltage output by the first output terminal and a voltage output by the second output terminal of the voltage differential generation circuit by a first voltage refers to: using a central value of the voltage output by the first output terminal and the voltage output by the second output terminal when the load driving circuit does not comprise the common mode voltage generation circuit as a reference, up-regulating or down-regulating the central value of the voltage output by the first output terminal and the voltage output by the second output terminal of the voltage differential generation circuit by the first voltage, that is, using the voltage output by the first output terminal and the voltage output by the second output terminal when the load driving circuit does not comprise the common mode voltage generation circuit as a reference, up-regulating or down-regulating the voltage output by the first output terminal and the voltage output by the second output terminal of the voltage differential generation circuit by the same voltage.

To be specific, in an embodiment, the reference voltage of the first operational amplifier in the voltage differential generation circuit 32 is regulated from a second voltage to a third voltage, and the reference voltage of the second operational amplifier in the voltage differential generation circuit 32 is regulated from the second voltage to a fourth voltage, wherein the third voltage satisfies equation

$${V}_{3} = \frac{{V}_{reg} + {V}_{1}}{N + 1}$$

and the fourth voltage satisfies equation

$${V}_{4} = \frac{{V}_{reg}}{2} + {V}_{1} .$$

In this way, the central value of the voltage output by the first output terminal and the voltage output by the second output terminal of the voltage differential generation circuit 32 are regulated by the first voltage. In the equations, V₃ denotes the third voltage, V_{reg} denotes a first input voltage, V₁ denotes a voltage, i.e., the first voltage, by which voltages output by the first output terminal and the second output terminal of the voltage differential generation circuit 32 are regulated; the first voltage or the second voltage is half of the first input voltage of the voltage differential generation circuit; and the first input voltage is a maximum value of the driving voltage that needs to be generated.

Specifically, in another embodiment, upon determining a range of the driving voltage to be generated, a voltage range of an input signal is regulated based on the range of the driving voltage by a fifth voltage, and reference voltages of a first operational amplifier and a second operational amplifier are regulated from a sixth voltage to a seventh voltage, wherein: the fifth voltage, the sixth voltage, the seventh voltage satisfy equation V₅=V₇−V₆, where V₅ denotes the sixth voltage, V₆ denotes the sixth voltage, V₇ denotes the seventh voltage, the sixth voltage is half of a maximum value of the driving voltage that needs to be generated, and the fifth voltage is equal to the first voltage.

In this embodiment, the load driving circuit is a single-terminal input driving circuit. The single-terminal input driving circuit herein refers to that: an input voltage in the voltage differential generation circuit is only connected relatively from an input terminal; simply speaking, the voltage differential generation circuit has only one input voltage.

The load may be a motor, wherein the motor may be specifically a haptic motor, for example, an ERM motor, or the like.

Based on the above load driving circuit, an embodiment of the present invention provides a touch apparatus, wherein the touch apparatus comprises a touch screen and a load driving circuit. When an operator touches the touch screen, a touch signal is generated and the touch signal generates a touch feedback via the load driving circuit, for example, a touch vibration feedback.

As illustrated in FIG. 3, the load driving circuit comprises a common mode voltage generation circuit 31 and a voltage differential generation circuit 32.

Regulating a central value of a voltage output by the first output terminal and a voltage output by the second output terminal of the voltage differential generation circuit 32 by a first voltage refers to: using a central value of the voltage output by the first output terminal and the voltage output by the second output terminal when the load driving circuit does not comprise the common mode voltage generation circuit 31 as a reference, up-regulating or down-regulating the central value of the voltage output by the first output terminal and the voltage output by the second output terminal of the voltage differential generation circuit 32 by the first voltage, that is, using the voltage output by the first output terminal and the voltage output by the second output terminal when the load driving circuit does not comprise the common mode voltage generation circuit 31 as a reference, up-regulating or down-regulating the voltage output by the first output terminal and the voltage output by the second output terminal of the voltage differential generation circuit 32 by the same voltage.

In this embodiment, the load driving circuit is a single-terminal input driving circuit. The single-terminal input driving circuit herein refers to that: an input voltage in the voltage differential generation circuit 32 is only connected relatively from an input terminal; simply speaking, the voltage differential generation circuit 32 has only one input voltage.

The load may be a motor, wherein the motor may be specifically a haptic motor, for example, an ERM motor, or the like.

### Embodiment 1

In this embodiment, as illustrated in FIG. 4A, the common mode voltage generation circuit 31 may comprise: a first resistor R1, a second resistor R2, and a third resistor R3; and the voltage differential generation circuit 32 may comprise: a fourth PMOSFET MP4, a fourth NMOSFET MN4, a fourth resistor R4, a fifth resistor R5, a sixth resistor R6, a seventh resistor R7, a first operational amplifier A1, a second operational amplifier A2, and a capacitor Cₐₚ.

The connection relations among various components of the load driving circuit as illustrated in FIG. 4A are as follows:

In the common mode voltage generation circuit 31, one terminal of the first resistor R1 is connected to a first input voltage, the other terminal of the first resistor R1 is connected to one terminal of the second resistor R2, one terminal of the third resistor R3 and a positive pole of the first operational amplifier A1 in the voltage differential generation circuit 32, the other terminal of the second resistor R2 is connected to a positive pole of the second operational amplifier A2 in the voltage differential generation circuit 32, the other terminal of the third resistor R3 is grounded, a resistance ratio of the first resistor R1 to the second resistor R2 to the third resistor R3 is R1:R2:R3=2:1:2.

In the voltage differential generation circuit 32, a gate of the fourth PMOSFET MP4 is connected to an input signal and a gate of the fourth NMOSFET MN4, a source of the fourth PMOSFET MP4 is connected to the first input voltage, a drain of the fourth PMOSFET MP4 is connected to one terminal of the fourth resistor R4 and a drain of the fourth NMOSFET MN4, a source of the fourth NMOSFET MN4 is grounded, the other terminal of the fourth resistor R4 is connected to one terminal of the fifth resistor R5, one terminal of the capacitor Cₐₚ and a negative pole of the first operational amplifier A1, the other terminal of the fifth resistor R5 is connected to the other terminal of the capacitor Cₐₚ, an output terminal of the first operational amplifier A1 and one terminal of the sixth resistor R6, the other terminal of the sixth resistor R6 is connected to a negative pole of the second operational amplifier A2 and one terminal of the seventh resistor R7, the other terminal of the seventh resistor R7 is connected to an output terminal of the second operational amplifier A2, the output terminal of the first operational amplifier A1 and the output terminal of the second operational amplifier A2 are respectively connected to two terminals of the load, a resistance ratio of the fifth resistor R5 to the fourth resistor is 1:1, and a resistance of the sixth resistor R6 is equal to that of the seventh resistor R7.

The input signal herein may be a pulse signal, for example, a PWM signal. The value of the first input voltage may be determined according to related working parameters of the load. For example, assume that the load is a motor, the value of the first input voltage may be determined according to the working voltage of the motor. For example, if the working voltage of the motor is 3 V, the first input voltage is 3 V. Herein, the working voltage of the motor may be determined according to the working voltage set for the motor before delivery from factory. For example, if the working voltage set for the motor before delivery from factory is 3 V, it is determined that the working voltage of the motor is 3 V. After the value of the first input voltage is determined, the first input voltage may be provided by a power supply capable of generating a constant alternate current voltage, for example, a voltage regulator or the like, for use by corresponding components in the load driving circuit, such that the load driving circuit generates a corresponding driving voltage. The regulator may be specifically an LDO regulator or the like. The first operational amplifier and the second operational amplifier may be both class-AB amplifiers. In this way, when the amplifier works, a great current may be output such that requirements of the circuit are accommodated.

For ease of description, in the description of the working principles of the load driving circuit as illustrated in FIG. 4A, the output terminal of the first operational amplifier A1 is referred to as a first output terminal of the voltage differential generation circuit 32, and the output terminal of the second operational amplifier A2 is referred to as a second output terminal of the voltage differential generation circuit 32; the voltage connected to the positive pole of the first operational amplifier A1 is referred to as V_{cmi}, and the voltage connected to the positive pole of the second operational amplifier A2 is referred to as K_{cmo}, the first input voltage is referred to as V_{reg}, the voltage output by the first output terminal is referred to as Vₒᵤₜ₁, and the voltage output by the second output terminal is referred to as Vₒᵤₜ₂.

The working principles of the load driving circuit as illustrated in the FIG. 4A are as follows:

When the load driving circuit works, a current I_{bp} is applied to the second resistor R2, and a flow direction of the current I_{bp} is from the second resistor R2 to the third resistor R3. Assume that the resistance of the first resistor R1 is 2R, then the resistance of the second resistor R2 is R, and the resistance of the third resistor R3 is 2R. In this case, a reference voltage of the first operational amplifier A1, that is, the voltage connected to the positive pole of the first operational amplifier A1 is

$${V}_{cmi} = \frac{{V}_{reg}}{2} + {I}_{bp} \times R ,$$

and correspondingly, a reference voltage of the second operational amplifier A2, that is, the voltage connected to the positive pole of the second operational amplifier A2 is

$${V}_{cmo} = \frac{{V}_{reg}}{2} + {I}_{bp} \times 2 R .$$

Under such circumstances, when the input signal is a low-level signal, the fourth PMOSFET MP4 is conducted and the fourth NMOSFET MN4 is turned off, such that the voltage of the input signal is V_{reg}. Since the reference voltage of the first operational amplifier A1 is

$${V}_{cmi} = \frac{{V}_{reg}}{2} + {I}_{bp} \times R$$

and the reference voltage of the second operational amplifier A2 is

$${V}_{cmo} = \frac{{V}_{reg}}{2} + {I}_{bp} \times 2 R ,$$

the voltage output by the first output terminal of the voltage differential generation circuit 32 is Vₒᵤₜ₁=V_{reg}+2R×I_{bp} and correspondingly the voltage output by the second output terminal of the voltage differential generation circuit 32 is Vₒᵤₜ₂=2R×I_{bp}, such that the driving voltage generated by the voltage differential generation circuit 32 is V_{driver}=Vₒᵤₜ₂−Vₒᵤₜ₁=−V_{reg}. Analogously, when the input signal is a high-level signal, the fourth PMOSFET MP4 is turned off and the fourth NMOSFET MN4 is conducted, such that the voltage of the input signal is 0. Since the reference voltage of the first operational amplifier A1 is

$${V}_{cmi} = \frac{{V}_{reg}}{2} + {I}_{bp} \times R$$

and the reference voltage of the second operational amplifier A2 is

$${V}_{cmo} = \frac{{V}_{reg}}{2} + {I}_{bp} \times 2 R ,$$

the voltage output by the first output terminal of the voltage differential generation circuit 32 is Vₒᵤₜ₁=R×2I_{bp} and correspondingly the voltage output by the second output terminal of the voltage differential generation circuit 32 is Vₒᵤₜ₂=V_{reg}+R×2I_{bp}, such that the driving voltage generated by the voltage differential generation circuit 32 is V_{driver}=Vₒᵤₜ₂−Vₒᵤₜ₁=V_{reg}.

In conclusion, the reference voltages of the first operational amplifier A1 and the second operational amplifier A2 are regulated such that a central value of the voltage output by the first output terminal and the voltage output by the second output terminal of the voltage differential generation circuit 32 is up-regulated, that is, up-regulated from

$$\frac{{V}_{reg}}{2} to \frac{{V}_{reg}}{2} + {I}_{bp} \times 2 R .$$

To be specific, the central value of the voltage output by the first output terminal and the voltage output by the second output terminal of the voltage differential generation circuit 32 is up-regulated by I_{bp}×2R, that is, the first voltage is I_{bp}×2R.

When the input signal is a low-level signal, the duty cycle of the input signal is 0; and when the input signal is a high-level signal, the duty cycle of the input signal is 100%. The current I_{bp} applied on the second resistor R2 may be generated by an additional circuit.

The principles of down-regulating the central value of the voltage output by the first output terminal and the voltage output by the second output terminal in the voltage differential generation circuit 32 are the same as those of up-regulating the central value of the voltage output by the first output terminal and the voltage output by the second output terminal in the voltage differential generation circuit 32.

Based on FIG. 4A, when the voltage differential generation circuit is subjected to an N-fold gain, that is, a resistance ratio of the fifth resistor R5 and the fourth resistor R4 is N:1, in another load driving circuit according to this embodiment, as illustrated in FIG. 4B, the common mode voltage generation circuit 31 may comprise: an eleventh resistor R11, a twelfth resistor R12, a thirteenth resistor R13, and a fourteenth resistor R14; and the voltage differential generation circuit 32 may comprise: a fourth PMOSFET MP4, a fourth NMOSFET MN4, a fourth resistor R4, a fifth resistor R5, a sixth resistor R6, a seventh resistor R7, a first operational amplifier A1, a second operational amplifier A2, and a capacitor Cₐₚ.

The connection relations among various components of the load driving circuit as illustrated in FIG. 4B are as follows:

In the common mode voltage generation circuit 31, one terminal of the eleventh resistor R11 is connected to the first input voltage and the other terminal of the eleventh resistor R11 is connected to one terminal of the thirteenth resistor R13 and a positive pole of the first operational amplifier A1 in the voltage differential generation circuit 32, one terminal of the twelfth resistor R12 is connected to the first input voltage and the other terminal of the twelfth resistor R12 is connected to one terminal of the fourteenth resistor R14 and a positive pole of the second operational amplifier A2 in the voltage differential generation circuit 32, the other terminal of the thirteenth resistor R13 and the other terminal of the fourteenth resistor R14 are both grounded, a resistance ratio of the eleventh resistor R11 to the thirteenth resistor R13 is N:1, and a resistance ratio of the twelfth resistor R13 to the fourteenth resistor R14 is 1:1.

In the voltage differential generation circuit 32, a gate of the fourth PMOSFET MP4 is connected to an input signal and a gate of the fourth NMOSFET MN4, a source of the fourth PMOSFET MP4 is connected to a fourth input voltage, a drain of the fourth PMOSFET MP4 is connected to one terminal of the fourth resistor R4 and a drain of the fourth NMOSFET MN4, a source of the fourth NMOSFET MN4 is grounded, the other terminal of the fourth resistor R4 is connected to one terminal of the fifth resistor R5, one terminal of the capacitor Cₐₚ and a negative pole of the first operational amplifier A1, the other terminal of the fifth resistor R5 is connected to the other terminal of the capacitor Cₐₚ, an output terminal of the first operational amplifier A1 and one terminal of the sixth resistor R6, the other terminal of the sixth resistor R6 is connected to a negative pole of the second operational amplifier A2 and one terminal of the seventh resistor R7, the other terminal of the seventh resistor R7 is connected to an output terminal of the second operational amplifier A2, the output terminal of the first operational amplifier A1 and the output terminal of the second operational amplifier A2 are respectively connected to two terminals of the load, a resistance ratio of the fifth resistor R5 to the fourth resistor R4 is 1:1, a resistance of the sixth resistor R6 is equal to that of the seventh resistor R7, and the fourth input voltage is 1/N of the first input voltage.

The working principles of the load driving circuit as illustrated in FIG. 4B are analogous to those of the load driving circuit as illustrated in FIG. 4A. However, it should be noted that when the load driving circuit works, a current I₁ needs to be applied to the eleventh resistor R11, and a direction of the current I₁ is from the positive pole of the first operational amplifier A1 to the eleventh resistor R11; and a current I₂ needs to be applied to the twelfth resistor R12, and a direction of the current I₂ is from the positive pole of the second operational amplifier A2 to the twelfth resistor R12. Assume that the resistance of the thirteenth resistor R13 is R₁₃ and the resistance of the fourteenth resistor R14 is R₁₄, then

$${I}_{1} \times {R}_{13} = \frac{{I}_{2} \times {R}_{14}}{2 N} .$$

As seen from the above description, in the load driving circuit as illustrated in FIG. 4B, the common mode voltage generation circuit 31 regulates the reference voltage of the first operational amplifier in the voltage differential generation circuit 32 from a second voltage to a third voltage, and regulates the reference voltage of the second operational amplifier in the voltage differential generation circuit 32 from the second voltage to a fourth voltage, wherein the third voltage satisfies equation

$${V}_{3} = \frac{{V}_{reg} + {V}_{1}}{N + 1}$$

and the fourth voltage satisfies equation

$${V}_{4} = \frac{{V}_{reg}}{2} + {V}_{1} .$$

In this way, the central value of the voltage output by the first output terminal and the voltage output by the second output terminal of the voltage differential generation circuit 32 are regulated by the first voltage. In the equations, V₃ denotes the third voltage, V_{reg} denotes a first input voltage, V₁ denotes a voltage, i.e., the first voltage, by which voltages output by the first output terminal and the second output terminal of the voltage differential generation circuit 32 are regulated; the first voltage or the second voltage is half of the first input voltage of the voltage differential generation circuit; and the first input voltage is a maximum value of the driving voltage that needs to be generated. In this embodiment, the third voltage corresponds to V_{cmi} in the load driving circuit as illustrated in FIG. 4A, the fourth voltage corresponds to V_{cmo} in the load driving circuit as illustrated in FIG. 4A, V₁ corresponds to I_{bp}×2R in the load driving circuit as illustrated in FIG. 4A.

Herein, a central value of the voltage output by the first output terminal and the voltage output by the second output terminal of the voltage differential generation circuit 32 is regulated, such that when a duty cycle of an input signal is within a range of 0 to 100%, the first operational amplifier and the second operational amplifier in the voltage differential generation circuit 32 both work in a linear region, thereby ensuring fidelity of an output signal.

### Embodiment 2

In this embodiment, as illustrated in FIG. 5, the common mode voltage generation circuit 31 may comprise: an eighth resistor R8, a ninth resistor R9, a tenth resistor R10, a first PMOSFET MP1, a second PMOSFET MP2, a third PMOSFET MP3, a first NMOSFET MN1, a second NMOSFET MN2, a third NMOSFET MN3, a third operational amplifier A3, a fourth operational amplifier A4, a first buffer BUF1, and a second buffer BUF2; and the voltage differential generation circuit 32 may comprise: a fourth resistor R4, a fifth resistor R5, a sixth resistor R6, a seventh resistor R7, a first operational amplifier A1, a second operational amplifier A2, and a capacitor Cₐₚ.

The connection relations among various components of the load driving circuit as illustrated in FIG. 5 are as follows:

In the common mode voltage generation circuit 31, a gate of the first PMOSFET MP1 is connected to an input signal, a source of the first PMOSFET MP1 is connected to an output terminal of the first buffer BUF1, a drain of the first PMOSFET MP1 is connected to a drain of the first NMOSFET MN1 and one terminal of the fourth resistor R4 in the voltage differential generation circuit 32, an input terminal of the first buffer BUF1 is connected to a drain of the second PMOSFET MP2 and one terminal of the eighth resistor R8, a gate of the second PMOSFET MP2 is connected to a gate of the third PMOSFET MP3, a drain of the third PMOSFET MP3 and a drain of the third NMOSFET MN3, a source of the second PMOSFET MP2 is connected to a source of the third PMOSFET MP3 and a power supply, a gate of the first NMOSFET MN1 is connected to an input signal, a source of the first NMOSFET MN1 is connected to an output terminal of the second buffer BUF2, an input terminal of the second buffer BUF2 is connected to a drain of the second NMOSFET MN2 and one terminal of the ninth resistor R9, a gate of the second NMOSFET MN2 is connected to an output terminal of a third operational amplifier A3, a source of the second NMOSFET MN2 is connected to one terminal of the tenth resistor R10 and grounded, a positive pole of the third operational amplifier A3 is connected to the other terminal of the eighth resistor R8 and the other terminal of the ninth resistor R9, a negative pole of the third operational amplifier A3 is connected to a second input voltage, the other terminal of the tenth resistor R10 is connected to a source of the third NMOSFET MN3 and a negative pole of a fourth operational amplifier A4, a positive pole of the fourth operational amplifier A4 is connected to a third input voltage, an output terminal of the fourth operational amplifier A4 is connected to a gate of the third NMOSFET MN3, and a resistance of the eighth resistance R8 is equal to that of the ninth resistor R9.

In the voltage differential generation circuit 32, the other terminal of the fourth resistor R4 is connected to one terminal of the fifth resistor R5, one terminal of the capacitor Cₐₚ is connected to a negative pole of the first operational amplifier A1, the other terminal of the fifth resistor R5 is connected to the other terminal of the capacitor Cₐₚ, an output terminal of the first operational amplifier A1 and one terminal of the sixth resistor R6, the other terminal of the sixth resistor R6 is connected to a negative pole of the second operational amplifier A2 and one terminal of the seventh resistor R7, the other terminal of the seventh resistor R7 is connected to an output terminal of the second operational amplifier A2, a positive pole of the first operational amplifier A1 and a positive pole of the second operational amplifier A2 are both connected to a second input voltage, an output terminal of the first operational amplifier A1 and an output terminal of the second operational amplifier A2 are respectively connected to two terminals of the load, and a resistance of the sixth resistor R6 is equal to that of the seventh resistor R7.

The input signal herein may be a pulse signal, for example, a PWM signal. The value of the second input voltage is half of the voltage provided by the power supply. To be specific, a resistor may be serially connected between the power supply and the negative pole of the third operational amplifier A3 and a resistor may be serially connected between the power supply and the positive pole of the first operational amplifier A1 and the positive pole of the second operational amplifier A2, such that the value of the second input voltage is half of the voltage provided by the power supply. The power supply is directed to supply power for the load driving circuit. The value of the third input voltage is half of a reference voltage generated by a reference voltage generation circuit. To be specific, a resistor may be serially connected between the reference voltage generation circuit and the positive pole of the fourth operational amplifier A4, such that the value of the third input voltage is half of a reference voltage generated by a reference voltage generation circuit. The reference voltage generation circuit is directed to providing a bias voltage for the load driving circuit, such that various components in the entire load driving circuit are in a working state anytime. The first operational amplifier and the second operational amplifier are both class-AB amplifiers. In this way, when the amplifier works, a great current may be output such that requirements of the circuit are accommodated.

For ease of description, in the description of the working principles of the load driving circuit as illustrated in FIG. 5, the output terminal of the first operational amplifier A1 is referred to as a first output terminal of the voltage differential generation circuit 32, the output terminal of the second operational amplifier A2 is referred to as a second output terminal of the voltage differential generation circuit 32, the voltage output by the first output terminal is referred to as Vₒᵤₜ₁, the voltage output by the second output terminal is referred to as Vₒᵤₜ₂, a current flowing through the eighth resistor R8 and the ninth resistor R9 and flowing along a direction from the eighth resistor R8 to the ninth resistor R9 is referred to as I₁, a current flowing through the tenth resistor R10 and flowing along a direction from the drain of the third PMOSFET MP3 to the tenth resistor R10 is referred to as I₂, the voltage provided by the power supply is referred to as V_{DD}, the reference voltage generated by the reference voltage generation circuit is referred to as V_{bg}, and the working voltage of the load is referred to as V_{reg}. Herein, the value of the working voltage of the load may be determined according to related working parameters of the load. For example, assume that the load is a motor, the value of the first input voltage may be determined according to the working voltage of the motor. For example, if the working voltage of the motor is 3 V, the first input voltage is 3 V. After the value of the first input voltage is determined, the first input voltage may be provided by a power supply capable of generating a constant alternate current voltage, for example, a voltage regulator or the like, for use by corresponding components in the load driving circuit, such that the load driving circuit generates a corresponding driving voltage. The regulator may be specifically an LDO regulator or the like.

The working principles of the load driving circuit as illustrated in the FIG. 5 are as follows:

When the load driving circuit works, when the input signal is a low-level signal, the first PMOSFET MP1 is conducted and the first NMOSFET MN1 is turned off, such that the voltage of the input signal is

$$\frac{{V}_{DD} + {V}_{reg}}{2} .$$

In this case, since the reference voltages of the first operational amplifier A1 and the second operational amplifier A2, i.e., the voltages connected to the positive poles of the first and second operational amplifiers, are both

$$\frac{{V}_{DD}}{2} ,$$

the voltage output by the first output terminal of the voltage differential generation circuit 32 is

$${V}_{out 1} = \frac{{V}_{DD} + {V}_{reg}}{2}$$

and the voltage output by the second output terminal of the voltage differential generation circuit 32 is

$${V}_{out 2} = \frac{{V}_{DD} - {V}_{reg}}{2} ,$$

such that the driving voltage generated by the voltage differential generation circuit 32 is V_{driver}=Vₒᵤₜ₂−Vₒᵤₜ₁=−V_{reg}. Analogously, when the input signal is a high-level signal, the first NMOSFET MN1 is conducted and the first PMOSFET MP1 is turned off, such that the voltage of the input signal is

$$\frac{{V}_{DD} + {V}_{reg}}{2} .$$

In this case, since the reference voltages of the first operational amplifier A1 and the second operational amplifier A2 are both

$$\frac{{V}_{DD}}{2} ,$$

the voltage output by the first output terminal of the voltage differential generation circuit 32 is

$${V}_{out 1} = \frac{{V}_{DD} - {V}_{reg}}{2}$$

and the voltage output by the second output terminal of the voltage differential generation circuit 32 is

$${V}_{out 2} = \frac{{V}_{DD} + {V}_{reg}}{2} ,$$

such that the driving voltage generated by the voltage differential generation circuit 32 is V_{driver}=Vₒᵤₜ₂−Vₒᵤₜ₁=−V_{reg}.

In conclusion, a voltage range of the input signal is regulated from a range of 0 to V_{reg} to a range of

$$\frac{{V}_{DD} - {V}_{reg}}{2} to \frac{{V}_{DD} + {V}_{reg}}{2} ,$$

such that a central value of the voltage output by the first output terminal and the voltage output by the second output terminal of the voltage differential generation circuit 32 is up-regulated, that is, up-regulated from

$$\frac{{V}_{reg}}{2}$$

to

$$\frac{{V}_{DD}}{2} .$$

To be specific, the central value of the voltage output by the first output terminal and the voltage output by the second output terminal of the voltage differential generation circuit 32 is up-regulated by

$$\frac{{V}_{DD} - {V}_{reg}}{2} ,$$

that is, the first voltage is

$$\frac{{V}_{DD} - {V}_{reg}}{2} .$$

When the input signal is a low-level signal, the duty cycle of the input signal is 0; and when the input signal is a high-level signal, the duty cycle of the input signal is 100%.

In the load driving circuit as illustrated in FIG. 5, assume that the resistances of the eight resistor R8 and the ninth resistor R9 are both R₁ and the resistance of the tenth resistor R10 is R₂, then the following equation may be given:

$$\begin{matrix}{I}_{1} = \frac{{V}_{reg}}{2 \times {R}_{1}} & ( 1 ) \\ {I}_{2} = \frac{{V}_{bg}}{{R}_{2}} & ( 2 )\end{matrix}$$

### Therefore,

$${V}_{reg} = 2 \times \frac{{R}_{1}}{{R}_{2}} \times {V}_{bg} \times \frac{{I}_{1}}{{I}_{2}} \qquad ( 3 )$$

Since V_{bg} is a fixed value, in practice, when V_{reg} is determined, a ratio of R₁ to R₂ may be obtained according to equation (3), and thus specific values of R₁ and R₂ may be determined.

The principles of down-regulating the central value of the voltage output by the first output terminal and the voltage output by the second output terminal in the voltage differential generation circuit 32 are the same as those of up-regulating the central value of the voltage output by the first output terminal and the voltage output by the second output terminal in the voltage differential generation circuit 32.

As seen from the above description, in the load driving circuit as illustrated in FIG. 5, upon determining a range of the driving voltage to be generated, the common mode voltage generation circuit 31 regulates a voltage range of an input signal based on the range of the driving voltage by a fifth voltage, and regulates reference voltages of a first operational amplifier and a second operational amplifier from a sixth voltage to a seventh voltage, wherein: the fifth voltage, the sixth voltage, the seventh voltage satisfy equation V₅=V₇−V₆, where V₅ denotes the fifth voltage, V₆ denotes the sixth voltage, V₁ denotes the seventh voltage, the sixth voltage is half of a maximum value of the driving voltage that needs to be generated, and the fifth voltage is equal to the first voltage. Herein, V₅ corresponds to

$$\frac{{V}_{DD} - {V}_{reg}}{2} ,$$

V₆ corresponds to

$$\frac{{V}_{reg}}{2} ,$$

and V₇ corresponds to

$$\frac{{V}_{DD}}{2} .$$

Herein, a central value of the voltage output by the first output terminal and the voltage output by the second output terminal of the voltage differential generation circuit 32 is regulated, such that when a duty cycle of an input signal is within a range of 0 to 100%, the first operational amplifier and the second operational amplifier in the voltage differential generation circuit 32 both work in a linear region, thereby ensuring fidelity of an output signal.

Based on the above touch apparatus, an embodiment of the present invention provides an electronic device, wherein the electronic device comprises: a main board, a housing, and a touch apparatus. The touch apparatus comprises a touch screen and a load driving circuit. Under control of a controller on the main board, when an operator touches the touch screen, a touch signal is generated and the touch signal generates a touch feedback via the load driving circuit, for example, a touch vibration feedback. The controller may be a central processing unit (CPU).

As illustrated in FIG. 3, the load driving circuit comprises a common mode voltage generation circuit 31 and a voltage differential generation circuit 32.

When the voltage differential generation circuit 32 generates a driving voltage for driving a load, the common mode voltage generation circuit 31 regulates voltages output by a first output terminal and a second output terminal of the voltage differential generation circuit 32 by the same voltage value, such that a central value of a voltage output by the first output terminal and a voltage output by the second output terminal of the voltage differential generation circuit 32 is regulated by a first voltage. In this way, when a duty cycle of an input signal is within a range of 0 to 100%, the driving voltage generated by the voltage differential generation circuit 32 is in a linear relation with the duty cycle of the input signal, thereby ensuring fidelity of an output signal. The first voltage may be set according to the actual requirements, for example, 50 mV, 100 mV, 150 mV, 200 mV, or the like. Herein, assume that the voltage output by the first output terminal is Vₒᵤₜ₁ and the voltage output by the second output terminal is Vₒᵤₜ₂, then the central value is specifically calculates as:

$$\frac{{V}_{out 1} + {V}_{out 2}}{2} .$$

Regulating a central value of a voltage output by the first output terminal and a voltage output by the second output terminal of the voltage differential generation circuit 32 by a first voltage refers to: using a central value of the voltage output by the first output terminal and the voltage output by the second output terminal when the load driving circuit does not comprise the common mode voltage generation circuit 31 as a reference, up-regulating or down-regulating the central value of the voltage output by the first output terminal and the voltage output by the second output terminal of the voltage differential generation circuit 32 by the first voltage, that is, using the voltage output by the first output terminal and the voltage output by the second output terminal when the load driving circuit does not comprise the common mode voltage generation circuit 31 as a reference, up-regulating or down-regulating the voltage output by the first output terminal and the voltage output by the second output terminal of the voltage differential generation circuit 32 by the same voltage.

In this embodiment, the load driving circuit is a single-terminal input driving circuit. The single-terminal input driving circuit herein refers to that: an input voltage in the voltage differential generation circuit 32 is only connected relatively from an input terminal; simply speaking, the voltage differential generation circuit 32 has only one input voltage.

The load may be a motor, wherein the motor may be specifically a haptic motor, for example, an ERM motor, or the like.

### Embodiment 1

In this embodiment, as illustrated in FIG. 4A, the common mode voltage generation circuit 31 may comprise: a first resistor R1, a second resistor R2, and a third resistor R3; and the voltage differential generation circuit 32 may comprise: a fourth PMOSFET MP4, a fourth NMOSFET MN4, a fourth resistor R4, a fifth resistor R5, a sixth resistor R6, a seventh resistor R7, a first operational amplifier A1, a second operational amplifier A2, and a capacitor Cₐₚ.

The connection relations among various components of the load driving circuit as illustrated in FIG. 4A are as follows:

In the common mode voltage generation circuit 31, one terminal of the first resistor R1 is connected to a first input voltage, the other terminal of the first resistor R1 is connected to one terminal of the second resistor R2, one terminal of the third resistor R3 and a positive pole of the first operational amplifier A1 in the voltage differential generation circuit 32, the other terminal of the second resistor R2 is connected to a positive pole of the second operational amplifier A2 in the voltage differential generation circuit 32, the other terminal of the third resistor R3 is grounded, a resistance ratio of the first resistor R1 to the second resistor R2 to the third resistor R3 is R1:R2:R3=2:1:2.

In the voltage differential generation circuit 32, a gate of the fourth PMOSFET MP4 is connected to an input signal and a gate of the fourth NMOSFET MN4, a source of the fourth PMOSFET MP4 is connected to the first input voltage, a drain of the fourth PMOSFET MP4 is connected to one terminal of the fourth resistor R4 and a drain of the fourth NMOSFET MN4, a source of the fourth NMOSFET MN4 is grounded, the other terminal of the fourth resistor R4 is connected to one terminal of the fifth resistor R5, one terminal of the capacitor Cₐₚ and a negative pole of the first operational amplifier A1, the other terminal of the fifth resistor R5 is connected to the other terminal of the capacitor Cₐₚ, an output terminal of the first operational amplifier A1 and one terminal of the sixth resistor R6, the other terminal of the sixth resistor R6 is connected to a negative pole of the second operational amplifier A2 and one terminal of the seventh resistor R7, the other terminal of the seventh resistor R7 is connected to an output terminal of the second operational amplifier A2, the output terminal of the first operational amplifier A1 and the output terminal of the second operational amplifier A2 are respectively connected to two terminals of the load, a resistance ratio of the fifth resistor R5 to the fourth resistor is 1:1, and a resistance of the sixth resistor R6 is equal to that of the seventh resistor R7.

The input signal herein may be a pulse signal, for example, a PWM signal. The value of the first input voltage may be determined according to related working parameters of the load. For example, assume that the load is a motor, the value of the first input voltage may be determined according to the working voltage of the motor. For example, if the working voltage of the motor is 3 V, the first input voltage is 3 V. Herein, the working voltage of the motor may be determined according to the working voltage set for the motor before delivery from factory. For example, if the working voltage set for the motor before delivery from factory is 3 V, it is determined that the working voltage of the motor is 3 V. After the value of the first input voltage is determined, the first input voltage may be provided by a power supply capable of generating a constant alternate current voltage, for example, a voltage regulator or the like, for use by corresponding components in the load driving circuit, such that the load driving circuit generates a corresponding driving voltage. The regulator may be specifically an LDO regulator or the like. The first operational amplifier and the second operational amplifier may be both class-AB amplifiers. In this way, when the amplifier works, a great current may be output such that requirements of the circuit are accommodated.

For ease of description, in the description of the working principles of the load driving circuit as illustrated in FIG. 4A, the output terminal of the first operational amplifier A1 is referred to as a first output terminal of the voltage differential generation circuit 32, and the output terminal of the second operational amplifier A2 is referred to as a second output terminal of the voltage differential generation circuit 32; the voltage connected to the positive pole of the first operational amplifier A1 is referred to as V_{cmi}, and the voltage connected to the positive pole of the second operational amplifier A2 is referred to as V_{cmo}, the first input voltage is referred to as V_{reg}, the voltage output by the first output terminal is referred to as Vₒᵤₜ₁, and the voltage output by the second output terminal is referred to as Vₒᵤₜ₂.

The working principles of the load driving circuit as illustrated in the FIG. 4A are as follows:

When the load driving circuit works, a current I_{bp} is applied to the second resistor R2, and a flow direction of the current I_{bp} is from the second resistor R2 to the third resistor R3. Assume that the resistance of the first resistor R1 is 2R, then the resistance of the second resistor R2 is R, and the resistance of the third resistor R3 is 2R. In this case, a reference voltage of the first operational amplifier A1, that is, the voltage connected to the positive pole of the first operational amplifier A1 is

$${V}_{cmi} = \frac{{V}_{reg}}{2} + {I}_{bp} \times R ,$$

and correspondingly, a reference voltage of the second operational amplifier A2, that is, the voltage connected to the positive pole of the second operational amplifier A2 is

$${V}_{cmo} = \frac{{V}_{reg}}{2} + {I}_{bp} \times 2 R .$$

Under such circumstances, when the input signal is a low-level signal, the fourth PMOSFET MP4 is conducted and the fourth NMOSFET MN4 is turned off, such that the voltage of the input signal is V_{reg}. Since the reference voltage of the first operational amplifier A1 is

$${V}_{cmi} = \frac{{V}_{reg}}{2} + {I}_{bp} \times R$$

and the reference voltage of the second operational amplifier A2 is

$${V}_{cmo} = \frac{{V}_{reg}}{2} + {I}_{bp} \times 2 R ,$$

the voltage output by the first output terminal of the voltage differential generation circuit 32 is Vₒᵤₜ₁=V_{reg}+2R×I_{bp} and correspondingly the voltage output by the second output terminal of the voltage differential generation circuit 32 is Vₒᵤₜ₂=2R×I_{bp}, such that the driving voltage generated by the voltage differential generation circuit 32 is V_{driver}=Vₒᵤₜ₂−Vₒᵤₜ₁=−V_{reg}. Analogously, when the input signal is a high-level signal, the fourth PMOSFET MP4 is turned off and the fourth NMOSFET MN4 is conducted, such that the voltage of the input signal is 0. Since the reference voltage of the first operational amplifier A1 is

$${V}_{cmi} = \frac{{V}_{reg}}{2} + {I}_{bp} \times R$$

and the reference voltage of the second operational amplifier A2 is

$${V}_{cmo} = \frac{{V}_{reg}}{2} + {I}_{bp} \times 2 R ,$$

the
voltage output by the first output terminal of the voltage differential generation circuit 32 is Vₒᵤₜ₁→R×2I_{bp} and correspondingly the voltage output by the second output terminal of the voltage differential generation circuit 32 is Vₒᵤₜ₂=V_{reg}+R×2I_{bp}, such that the driving voltage generated by the voltage differential generation circuit 32 is V_{driver}=Vₒᵤₜ₂−Vₒᵤₜ₁=−V_{reg}.

In conclusion, the reference voltages of the first operational amplifier A1 and the second operational amplifier A2 are regulated such that a central value of the voltage output by the first output terminal and the voltage output by the second output terminal of the voltage differential generation circuit 32 is up-regulated, that is, up-regulated from

$$\frac{{V}_{reg}}{2} to \frac{{V}_{reg}}{2} + {I}_{bp} \times 2 R .$$

To be specific, the central value of the voltage output by the first output terminal and the voltage output by the second output terminal of the voltage differential generation circuit 32 is up-regulated by I_{bp}×2R, that is, the first voltage is I_{bp}×2R.

When the input signal is a low-level signal, the duty cycle of the input signal is 0; and when the input signal is a high-level signal, the duty cycle of the input signal is 100%. The current I_{bp} applied on the second resistor R2 may be generated by an additional circuit.

The principles of down-regulating the central value of the voltage output by the first output terminal and the voltage output by the second output terminal in the voltage differential generation circuit 32 are the same as those of up-regulating the central value of the voltage output by the first output terminal and the voltage output by the second output terminal in the voltage differential generation circuit 32.

Based on FIG. 4A, when the voltage differential generation circuit is subjected to an N-fold gain, that is, a resistance ratio of the fifth resistor R5 and the fourth resistor R4 is N:1, in another load driving circuit according to this embodiment, as illustrated in FIG. 4B, the common mode voltage generation circuit 31 may comprise: an eleventh resistor R11, a twelfth resistor R12, a thirteenth resistor R13, and a fourteenth resistor R14; and the voltage differential generation circuit 32 may comprise: a fourth PMOSFET MP4, a fourth NMOSFET MN4, a fourth resistor R4, a fifth resistor R5, a sixth resistor R6, a seventh resistor R7, a first operational amplifier A1, a second operational amplifier A2, and a capacitor Cₐₚ.

The connection relations among various components of the load driving circuit as illustrated in FIG. 4B are as follows:

In the common mode voltage generation circuit 31, one terminal of the eleventh resistor R11 is connected to the first input voltage and the other terminal of the eleventh resistor R11 is connected to one terminal of the thirteenth resistor R13 and a positive pole of the first operational amplifier A1 in the voltage differential generation circuit 32, one terminal of the twelfth resistor R12 is connected to the first input voltage and the other terminal of the twelfth resistor R12 is connected to one terminal of the fourteenth resistor R14 and a positive pole of the second operational amplifier A2 in the voltage differential generation circuit 32, the other terminal of the thirteenth resistor R13 and the other terminal of the fourteenth resistor R14 are both grounded, a resistance ratio of the eleventh resistor R11 to the thirteenth resistor R13 is N:1, and a resistance ratio of the twelfth resistor R12 to the fourteenth resistor R14 is 1:1; and

In the voltage differential generation circuit 32, a gate of the fourth PMOSFET MP4 is connected to an input signal and a gate of the fourth NMOSFET MN4, a source of the fourth PMOSFET MP4 is connected to a fourth input voltage, a drain of the fourth PMOSFET MP4 is connected to one terminal of the fourth resistor R4 and a drain of the fourth NMOSFET MN4, a source of the fourth NMOSFET MN4 is grounded, the other terminal of the fourth resistor R4 is connected to one terminal of the fifth resistor R5, one terminal of the capacitor Cₐₚ and a negative pole of the first operational amplifier A1, the other terminal of the fifth resistor R5 is connected to the other terminal of the capacitor Cₐₚ, an output terminal of the first operational amplifier A1 and one terminal of the sixth resistor R6, the other terminal of the sixth resistor R6 is connected to a negative pole of the second operational amplifier A2 and one terminal of the seventh resistor R7, the other terminal of the seventh resistor R7 is connected to an output terminal of the second operational amplifier A2, the output terminal of the first operational amplifier A1 and the output terminal of the second operational amplifier A2 are respectively connected to two terminals of the load, a resistance ratio of the fifth resistor R5 to the fourth resistor R4 is 1:1, and a resistance of the sixth resistor R6 is equal to that of the seventh resistor R7. The fourth input voltage is 1/N of the first input voltage.

The working principles of the load driving circuit as illustrated in FIG. 4B are analogous to those of the load driving circuit as illustrated in FIG. 4A. However, it should be noted that when the load driving circuit works, a current I₁ needs to be applied to the eleventh resistor R11, and a direction of the current I₁I₂ is from the positive pole of the first operational amplifier A1 to the eleventh resistor R11; and a current I₂ needs to be applied to the twelfth resistor R12, and a direction of the current I₂ is from the positive pole of the second operational amplifier A2 to the twelfth resistor R12. Assume that the resistance of the thirteenth resistor R13 is R₁₃ and the resistance of the fourteenth resistor R14 is R₁₄, then

$${I}_{1} \times {R}_{13} = \frac{{I}_{2} \times {R}_{14}}{2 N} .$$

As seen from the above description, in the load driving circuit as illustrated in FIG. 4B, the common mode voltage generation circuit 31 regulates the reference voltage of the first operational amplifier in the voltage differential generation circuit 32 from a second voltage to a third voltage, and regulates the reference voltage of the second operational amplifier in the voltage differential generation circuit 32 from the second voltage to a fourth voltage, wherein the third voltage satisfies equation

$${V}_{3} = \frac{{V}_{reg} + {V}_{1}}{N + 1}$$

and the fourth voltage satisfies equation

$${V}_{4} = \frac{{V}_{reg}}{2} + {V}_{1} .$$

In this way, the central value of the voltage output by the first output terminal and the voltage output by the second output terminal of the voltage differential generation circuit 32 are regulated by the first voltage. In the equations, V₃ denotes the third voltage, V_{reg} denotes a first input voltage, V₁ denotes a voltage, i.e., the first voltage, by which voltages output by the first output terminal and the second output terminal of the voltage differential generation circuit 32 are regulated; the first voltage or the second voltage is half of the first input voltage of the voltage differential generation circuit; and the first input voltage is a maximum value of the driving voltage that needs to be generated. In this embodiment, the third voltage corresponds to V_{cmi} in the load driving circuit as illustrated in FIG. 4A, the fourth voltage corresponds to V_{cmo} in the load driving circuit as illustrated in FIG. 4A, V₁ corresponds to I_{bp}×2R in the load driving circuit as illustrated in FIG. 4A.

Herein, a central value of the voltage output by the first output terminal and the voltage output by the second output terminal of the voltage differential generation circuit 32 is regulated, such that when a duty cycle of an input signal is within a range of 0 to 100%, the first operational amplifier and the second operational amplifier in the voltage differential generation circuit 32 both work in a linear region, thereby ensuring fidelity of an output signal.

### Embodiment 2

In this embodiment, as illustrated in FIG. 5, the common mode voltage generation circuit 31 may comprise: an eighth resistor R8, a ninth resistor R9, a tenth resistor R10, a first PMOSFET MP1, a second PMOSFET MP2, a third PMOSFET MP3, a first NMOSFET MN1, a second NMOSFET MN2, a third NMOSFET MN3, a third operational amplifier A3, a fourth operational amplifier A4, a first buffer BUF1, and a second buffer BUF2; and the voltage differential generation circuit 32 may comprise: a fourth resistor R4, a fifth resistor R5, a sixth resistor R6, a seventh resistor R7, a first operational amplifier A1, a second operational amplifier A2, and a capacitor Cₐₚ.

The connection relations among various components of the load driving circuit as illustrated in FIG. 5 are as follows:

In the common mode voltage generation circuit 31, a gate of the first PMOSFET MP1 is connected to an input signal, a source of the first PMOSFET MP1 is connected to an output terminal of the first buffer BUF1, a drain of the first PMOSFET MP1 is connected to a drain of the first NMOSFET MN1 and one terminal of the fourth resistor R4 in the voltage differential generation circuit 32, an input terminal of the first buffer BUF1 is connected to a drain of the second PMOSFET MP2 and one terminal of the eighth resistor R8, a gate of the second PMOSFET MP2 is connected to a gate of the third PMOSFET MP3, a drain of the third PMOSFET MP3 and a drain of the third NMOSFET MN3, a source of the second PMOSFET MP2 is connected to a source of the third PMOSFET MP3 and a power supply, a gate of the first NMOSFET MN1 is connected to an input signal, a source of the first NMOSFET MN1 is connected to an input terminal of the second buffer BUF2, an output terminal of the second buffer BUF2 is connected to a drain of the second NMOSFET MN2 and one terminal of the ninth resistor R9, a gate of the second NMOSFET MN2 is connected to an output terminal of a third operational amplifier A3, a source of the second NMOSFET MN2 is connected to one terminal of the tenth resistor R10 and grounded, a positive pole of the third operational amplifier A3 is connected to the other terminal of the eighth resistor R8 and the other terminal of the ninth resistor R9, a negative pole of the third operational amplifier A3 is connected to a second input voltage, the other terminal of the tenth resistor R10 is connected to a source of the third NMOSFET MN3 and a negative pole of a fourth operational amplifier A4, a positive pole of the fourth operational amplifier A4 is connected to a third input voltage, an output terminal of the fourth operational amplifier A4 is connected to a gate of the third NMOSFET MN3, and a resistance of the eighth resistance R8 is equal to that of the ninth resistor R9.

In the voltage differential generation circuit 32, the other terminal of the fourth resistor R4 is connected to one terminal of the fifth resistor R5, one terminal of the capacitor Cₐₚ is connected to a negative pole of the first operational amplifier A1, the other terminal of the fifth resistor R5 is connected to the other terminal of the capacitor Cₐₚ, an output terminal of the first operational amplifier A1 and one terminal of the sixth resistor R6, the other terminal of the sixth resistor R6 is connected to a negative pole of the second operational amplifier A2 and one terminal of the seventh resistor R7, the other terminal of the seventh resistor R7 is connected to an output terminal of the second operational amplifier A2, a positive pole of the first operational amplifier A1 and a positive pole of the second operational amplifier A2 are both connected to a second input voltage, an output terminal of the first operational amplifier A1 and an output terminal of the second operational amplifier A2 are respectively connected to two terminals of the load, and a resistance of the sixth resistor R6 is equal to that of the seventh resistor R7.

The input signal herein may be a pulse signal, for example, a PWM signal. The value of the second input voltage is half of the voltage provided by the power supply. To be specific, a resistor may be serially connected between the power supply and the negative pole of the third operational amplifier A3 and a resistor may be serially connected between the power supply and the positive pole of the first operational amplifier A1 and the positive pole of the second operational amplifier A2, such that the value of the second input voltage is half of the voltage provided by the power supply. The power supply is directed to supply power for the load driving circuit. The value of the third input voltage is half of a reference voltage generated by a reference voltage generation circuit. To be specific, a resistor may be serially connected between the reference voltage generation circuit and the positive pole of the fourth operational amplifier A4, such that the value of the third input voltage is half of a reference voltage generated by a reference voltage generation circuit. The reference voltage generation circuit is directed to providing a bias voltage for the load driving circuit, such that various components in the entire load driving circuit are in a working state anytime. The first operational amplifier and the second operational amplifier are both class-AB amplifiers. In this way, when the amplifier works, a great current may be output such that requirements of the circuit are accommodated.

For ease of description, in the description of the working principles of the load driving circuit as illustrated in FIG. 5, the output terminal of the first operational amplifier Al is referred to as a first output terminal of the voltage differential generation circuit 32, the output terminal of the second operational amplifier A2 is referred to as a second output terminal of the voltage differential generation circuit 32, the voltage output by the first output terminal is referred to as Vₒᵤₜ₁, the voltage output by the second output terminal is referred to as Vₒᵤₜ₂, a current flowing through the eighth resistor R8 and the ninth resistor R9 and flowing along a direction from the eighth resistor R8 to the ninth resistor R9 is referred to as I₁, a current flowing through the tenth resistor R10 and flowing along a direction from the drain of the third PMOSFET MP3 to the tenth resistor R10 is referred to as I₂, the voltage provided by the power supply is referred to as V_{DD}, the reference voltage generated by the reference voltage generation circuit is referred to as V_{bg}, and the working voltage of the load is referred to as V_{reg}. Herein, the value of the working voltage of the load may be determined according to related working parameters of the load. For example, assume that the load is a motor, the value of the first input voltage may be determined according to the working voltage of the motor. For example, if the working voltage of the motor is 3 V, the first input voltage is 3 V. After the value of the first input voltage is determined, the first input voltage may be provided by a power supply capable of generating a constant alternate current voltage, for example, a voltage regulator or the like, for use by corresponding components in the load driving circuit, such that the load driving circuit generates a corresponding driving voltage. The regulator may be specifically an LDO regulator or the like.

The working principles of the load driving circuit as illustrated in the FIG. 5 are as follows:

When the load driving circuit works, when the input signal is a low-level signal, the first PMOSFET MP1 is conducted and the first NMOSFET MN1 is turned off, such that the voltage of the input signal is V_{DD}+V_{reg}/2. In this case, since the reference voltages of the first operational amplifier A1 and the second operational amplifier A2, i.e., the voltages connected to the positive poles of the first and second operational amplifiers, are both V_{DD}/2, the voltage output by the first output terminal of the voltage differential generation circuit 32 is

$${V}_{out 1} = \frac{{V}_{DD} + {V}_{reg}}{2}$$

and the voltage output by the second output terminal of the voltage differential generation circuit 32 is

$${V}_{out 2} = \frac{{V}_{DD} - {V}_{reg}}{2} ,$$

such that the driving voltage generated by the voltage differential generation circuit 32 is V_{driver}=Vₒᵤₜ₂−Vₒᵤₜ₁=−V_{reg}. Analogously, when the input signal is a high-level signal, the first NMOSFET MN1 is conducted and the first PMOSFET MP1 is turned off, such that the voltage of the input signal is

$$\frac{{V}_{DD} - {V}_{reg}}{2} .$$

In this case, since the reference voltages of the first operational amplifier A1 and the second operational amplifier A2 are both

$${V}_{out 1} = \frac{{V}_{DD} - {V}_{reg}}{2}$$

the voltage output by the first output terminal of the voltage differential generation circuit 32 is

$$\frac{{V}_{DD}}{2} ,$$

and the voltage output by the second output terminal of the voltage differential generation circuit 32 is

$${V}_{out 2} = \frac{{V}_{DD } + {V}_{reg}}{2} ,$$

such that the driving voltage generated by the voltage differential generation circuit 32 is V_{driver}=Vₒᵤₜ₂−Vₒᵤₜ₁=−V_{reg}.

In conclusion, a voltage range of the input signal is regulated from a range of 0 to V_{reg} to a range of

$$\frac{{V}_{DD} - {V}_{reg}}{2} to \frac{{V}_{DD} - {V}_{reg}}{2} ,$$

such that a central value of the voltage output by the first output terminal and the voltage output by the second output terminal of the voltage differential generation circuit 32 is up-regulated, that is, up-regulated from

$$\frac{{V}_{reg}}{2}$$

to

$$\frac{{V}_{DD}}{2} .$$

To be specific, the central value of the voltage output by the first output terminal and the voltage output by the second output terminal of the voltage differential generation circuit 32 is up-regulated by

$$\frac{{V}_{DD} - {V}_{reg}}{2} ,$$

that is, the first voltage is

$$\frac{{V}_{DD} - {V}_{reg}}{2} .$$

When the input signal is a low-level signal, the duty cycle of the input signal is 0; and when the input signal is a high-level signal, the duty cycle of the input signal is 100%.

In the load driving circuit as illustrated in FIG. 5, assume that the resistances of the eight resistor R8 and the ninth resistor R9 are both R₁ and the resistance of the tenth resistor R10 is R₂, then the following equation may be given:

$$\begin{matrix}{I}_{1} = \frac{{V}_{reg}}{2 \times {R}_{1}} & ( 1 ) \\ {I}_{2} = \frac{{V}_{bg}}{{R}_{2}} & ( 2 )\end{matrix}$$

Therefore,

$${V}_{reg} = 2 \times \frac{{R}_{1}}{{R}_{2}} \times {V}_{bg} \times \frac{{I}_{1}}{{I}_{2}} \qquad ( 3 )$$

Since V_{bg} is a fixed value, in practice, when V_{reg} is determined, a ratio of R₁ to R₂ may be obtained according to equation (3), and thus specific values of R₁ and R₂ may be determined.

The principles of down-regulating the central value of the voltage output by the first output terminal and the voltage output by the second output terminal in the voltage differential generation circuit 32 are the same as those of up-regulating the central value of the voltage output by the first output terminal and the voltage output by the second output terminal in the voltage differential generation circuit 32.

As seen from the above description, in the load driving circuit as illustrated in FIG. 5, upon determining a range of the driving voltage to be generated, the common mode voltage generation circuit 31 regulates voltage range of an input signal is regulated based on the range of the driving voltage by a fifth voltage, and regulates reference voltages of a first operational amplifier and a second operational amplifier from a sixth voltage to a seventh voltage, wherein: the fifth voltage, the sixth voltage, the seventh voltage satisfy equation V₅=V₇−V₆, where V₅ denotes the fifth voltage, V₆ denotes the sixth voltage, V₇ denotes the seventh voltage, the sixth voltage is half of a maximum value of the driving voltage that needs to be generated, and the fifth voltage is equal to the first voltage. Herein, V₅ corresponds to

$$\frac{{V}_{DD} - {V}_{reg}}{2} ,$$

V₆ corresponds to

$$\frac{{V}_{reg}}{2} ,$$

and V₇ , corresponds to

$$\frac{{V}_{DD}}{2} .$$

Herein, a central value of the voltage output by the first output terminal and the voltage output by the second output terminal of the voltage differential generation circuit 32 is regulated, such that when a duty cycle of an input signal is within a range of 0 to 100%, the first operational amplifier and the second operational amplifier in the voltage differential generation circuit 32 both work in a linear region, thereby ensuring fidelity of an output signal.

The electronic device herein may be a mobile phone, an iPad, a laptop, or the like.

FIG. 6 is a schematic view of a simulation result obtained with the technical solution according to Embodiment 1 of the present invention. The simulation conditions are as follows: The resistance of the load is 15 ohms, the working voltage of the load is 3 V, a range of the driving voltage that needs to be generated is 0 to 3 V. The simulation result indicates that: With the technical solution according to the embodiment of the present invention, when the duty cycle of the input signal is within a range of 0 to 100%, the generated driving voltage is completely in a linear relation with the duty cycle of the input signal.

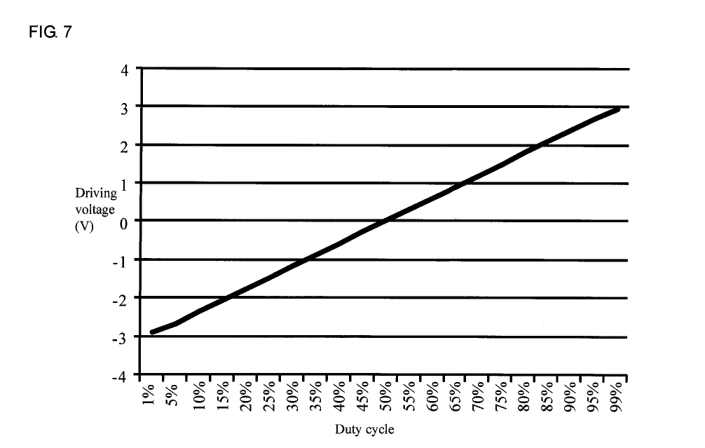

In the mean time, for better illustration of the technical solutions according to the embodiment of the present invention, the generated driving voltage is completely in a linear relation with the duty cycle of the input signal, an integrated circuit (IC) is fabricated with the technical solution according to Embodiment 1 of the present invention, and the generated driving voltage is tested, wherein the test temperature is 25° C.; the test conditions are as follows: the resistance of the load is 15 ohms and the working voltage of the load is 3 V, the range of the driving voltage that needs to be generated is 0 to 3 V. Then, the test result is as illustrated in FIG. 7.

As seen from FIG. 7, the duty cycle of the input signal is in a linear relation with the generated driving voltage. This further indicates that, with the technical solutions according to the embodiments of the present invention, when the duty cycle of the input signal is within a range of 0 to 100%, the generated driving voltage is in a linear relation with the duty cycle of the input signal, thereby ensuring fidelity of an output signal.

The above embodiments are merely preferred embodiments of the present invention, but are not intended to limit the protection scope of the present invention.

What is claimed is:

1. A load driving circuit, comprising:
a voltage differential generation circuit configured to generate a driving voltage for driving a load; and
a common mode voltage generation circuit configured to, when the voltage differential generation circuit generates the driving voltage for driving the load, adjust the voltages output by a first output terminal and a second output terminal of the voltage differential generation circuit by a same voltage value.

2. The load driving circuit according to claim 1, wherein the common mode voltage generation circuit is configured to adjust a reference voltage of a first operational amplifier of the voltage differential generation circuit from a second voltage to a third voltage V₃, and adjust a reference voltage of a second operational amplifier of the voltage differential generation circuit from the second voltage to a fourth voltage V₄, the third voltage
$${V}_{3} = \frac{{V}_{reg} + {V}_{1}}{N + 1} ,$$
and the fourth voltage
$${V}_{4} = \frac{{V}_{reg}}{2} + {V}_{1} ,$$
where V₃ represents the third voltage, V_{reg} represents a first input voltage, V₁ represents a voltage by which voltages output by the first output terminal and the second output terminal of the voltage differential generation circuit are adjusted, N represents a gain of the voltage differential generation circuit; the second voltage is a half of the first input voltage of the voltage differential generation circuit; and the first input voltage is a maximum value of the driving voltage to be generated.

3. The load driving circuit according to claim 2, wherein the common mode voltage generation circuit comprises: an eleventh resistor, a twelfth resistor, a thirteenth resistor, and a fourteenth resistor; and
the voltage different generation circuit comprises: a fourth p-channel metal-oxide-semiconductor field-effect transistor (PMOSFET), a fourth n-channel metal-oxide-semiconductor field-effect transistor (NMOSFET), a fourth resistor, a fifth resistor, a sixth resistor, a seventh resistor, a first operational amplifier, a second operational amplifier, and a capacitor.

4. The load driving circuit according to claim 3, wherein in the common mode voltage generation circuit, one terminal of the eleventh resistor is connected to the first input voltage, and the other terminal of the eleventh resistor is connected to one terminal of the thirteenth resistor and a positive pole of the first operational amplifier in the voltage differential generation circuit, one terminal of the twelfth resistor is connected to the first input voltage, and the other terminal of the twelfth resistor is connected to one terminal of the fourteenth resistor and a positive pole of the second operational amplifier in the voltage differential generation circuit, the other terminal of the thirteenth resistor and the other terminal of the fourteenth resistor are grounded, a resistance ratio of the eleventh resistor to the thirteenth resistor is N:1, and a resistance ratio of the twelfth resistor to the fourteenth resistor is 1:1; and
in the voltage differential generation circuit, a gate of the fourth PMOSFET is connected to an input signal and a gate of the fourth NMOSFET, a source of the fourth PMOSFET is connected to the first input voltage, a drain of the fourth PMOSFET is connected to one terminal of the fourth resistor and a drain of the fourth NMOSFET, a source of the fourth NMOSFET is grounded, the other terminal of the fourth resistor is connected to one terminal of the fifth resistor, one terminal of the capacitor and a negative pole of the first operational amplifier, the other terminal of the fifth resistor is connected to the other terminal of the capacitor, an output terminal of the first operational amplifier and one terminal of the sixth resistor, the other terminal of the sixth resistor is connected to a negative pole of the second operational amplifier and one terminal of the seventh resistor, the other terminal of the seventh resistor is connected to an output terminal of the second operational amplifier, the output terminal of the first operational amplifier and the output terminal of the second operational amplifier are respectively connected to two terminals of the load, a resistance ratio of the fifth resistor to the fourth resistor is N:1, a resistance of the sixth resistor R6 is equal to that of the seventh resistor R7, and the fourth input voltage is 1/N of the first input voltage.

5. The load driving circuit according to claim 1, wherein the common mode voltage generation circuit is configured to, upon determining a range of the driving voltage to be generated, adjust a voltage range of an input signal based on the range of the driving voltage by a fifth voltage V₅, and adjust reference voltages of a first operational amplifier and a second operational amplifier from a sixth voltage V₆ to a seventh voltage V₇, and the fifth voltage V₅, the sixth voltage V₆, the seventh voltage V₇ satisfy the equation V₅=V₇−V₆, where the sixth voltage V₆ is a half of a maximum value of the driving voltage to be generated.

6. The load driving circuit according to claim 5, wherein the common mode voltage generation circuit comprises: an eighth resistor, a ninth resistor, a tenth resistor, a first p-channel metal-oxide-semiconductor field-effect transistor (PMOSFET), a second PMOSFET, a third PMOSFET, a first n-channel metal-oxide-semiconductor field-effect transistor (NMOSFET), a second NMOSFET, a third NMOSFET, a third operational amplifier, a fourth operational amplifier, a first buffer, and a second buffer; and
the voltage differential generation circuit comprises: a fourth resistor, a fifth resistor, a sixth resistor, a seventh resistor, a first operational amplifier, a second operational amplifier, and a capacitor.

7. The load driving circuit according to claim 6, wherein in the common mode voltage generation circuit, a gate of the first PMOSFET is connected to an input signal, a source of the first PMOSFET is connected to an output terminal of the first buffer, a drain of the first PMOSFET is connected to a drain of the first NMOSFET and one terminal of the fourth resistor in the voltage differential generation circuit, an input terminal of the first buffer is connected to a drain of the second PMOSFET and one terminal of the eighth resistor, a gate of the second PMOSFET is connected to a gate of the third PMOSFET, a drain of the third PMOSFET and a drain of the third NMOSFET, a source of the second PMOSFET is connected to a source of the third PMOSFET and a power supply, a gate of the first NMOSFET is connected to an input signal, a source of the first NMOSFET is connected to an output terminal of the second buffer, an input terminal of the second buffer is connected to a drain of the second NMOSFET and one terminal of the ninth resistor, a gate of the second NMOSFET is connected to an output terminal of a third operational amplifier, a source of the second NMOSFET is connected to one terminal of the tenth resistor and grounded, a positive pole of the third operational amplifier is connected to the other terminal of the eighth resistor and the other terminal of the ninth resistor, a negative pole of the third operational amplifier is connected to a second input voltage, the other terminal of the tenth resistor is connected to a source of the third NMOSFET and a negative pole of a fourth operational amplifier, a positive pole of the fourth operational amplifier is connected to a third input voltage, an output terminal of the fourth operational amplifier is connected to a gate of the third NMOSFET, and a resistance of the eighth resistance is equal to that of the ninth resistor; and
in the voltage differential generation circuit, the other terminal of the fourth resistor is connected to one terminal of the fifth resistor, one terminal of the capacitor is connected to a negative pole of the first operational amplifier, the other terminal of the fifth resistor is connected to the other terminal of the capacitor, an output terminal of the first operational amplifier and one terminal of the sixth resistor, the other terminal of the sixth resistor is connected to a negative pole of the second operational amplifier and one terminal of the seventh resistor, the other terminal of the seventh resistor is connected to an output terminal of the second operational amplifier, a positive pole of the first operational amplifier and a positive pole of the second operational amplifier are both connected to a second input voltage, an output terminal of the first operational amplifier and an output terminal of the second operational amplifier are respectively connected to two terminals of the load, and a resistance of the sixth resistor is equal to that of the seventh resistor.

8. The load driving circuit according to claim 1, wherein the load is a haptic motor.

9. A load driving method, comprising:
when a voltage differential generation circuit generates a driving voltage for driving a load, adjusting voltages output by a first output terminal and a second output terminal of the voltage differential generation circuit by a same voltage value.

10. The method according to claim 9, wherein the step of adjusting voltages output by a first output terminal and a second output terminal of the voltage differential generation circuit by a same voltage value comprises:
adjusting a reference voltage of a first operational amplifier of the voltage differential generation circuit from a second voltage to a third voltage V₃, and adjusting a reference voltage of a second operational amplifier of the voltage differential generation circuit from the second voltage to a fourth voltage V₄, wherein the third voltage
$${V}_{3} = \frac{{V}_{reg} + {V}_{1}}{N + 1} ,$$
and the fourth voltage
$${V}_{4} = \frac{{V}_{reg}}{2} + {V}_{1} ;$$
where V₃ represents the third voltage, V_{reg} represents a first input voltage, V₁ represents a voltage by which voltages output by the first output terminal and the second output terminal of the voltage differential generation circuit are adjusted, N represents a gain of the voltage differential generation circuit; the second voltage is half of the first input voltage of the voltage differential generation circuit; and the first input voltage is a maximum value of the driving voltage that needs to be generated.

11. The method according to claim 9, wherein the step of adjusting voltages output by a first output terminal and a second output terminal of the voltage differential generation circuit by a same voltage value comprises:
upon determining a range of the driving voltage to be generated, adjusting a voltage range of an input signal based on the range of the driving voltage by a fifth voltage V₅, and adjusting reference voltages of a first operational amplifier and a second operational amplifier from a sixth voltage V₆ to a seventh voltage V₇, wherein: the fifth voltage V₅, the sixth voltage V₆, the seventh voltage V, satisfy equation V₅=V₇−V₆, where the sixth voltage V₆ is a half of a maximum value of the driving voltage required to be generated.

12. A touch apparatus, comprising a touch screen and a load driving circuit, wherein the load driving circuit comprises:
a voltage differential generation circuit configured to generate a driving voltage for driving a load; and
a common mode voltage generation circuit configured to, when the voltage differential generation circuit generates the driving voltage for driving the load, adjust voltages output by a first output terminal and a second output terminal of the voltage differential generation circuit by a same voltage value.

13. The touch apparatus according to claim 12, wherein the common mode voltage generation circuit is configured to adjust a reference voltage of a first operation amplifier of the voltage differential generation circuit from a second voltage to a third voltage V₃, and adjust a reference voltage of a second operation amplifier of the voltage differential generation circuit from the second voltage to a fourth voltage V₄, the third voltage
$${V}_{3} = \frac{{V}_{reg} + {V}_{1}}{N + 1} ,$$
and the fourth voltage
$${V}_{4} = \frac{{V}_{reg}}{2} + {V}_{1} ,$$
where V_{reg} represents a first input voltage, V₁ represents a voltage by which voltages output by the first output terminal and the second output terminal of the voltage differential generation circuit are regulated, N represents a gain of the voltage differential generation circuit; the second voltage is a half of the first input voltage of the voltage differential generation circuit; and the first input voltage is a maximum value of the driving voltage to be generated.

14. The touch apparatus according to claim 13, wherein the common mode voltage generation circuit comprises: an eleventh resistor, a twelfth resistor, a thirteenth resistor, and a fourteenth resistor; and
the voltage differential generation circuit comprises: a fourth p-channel metal-oxide-semiconductor field-effect transistor (PMOSFET), a fourth n-channel metal-oxide-semiconductor field-effect transistor (NMOSFET), a fourth resistor, a fifth resistor, a sixth resistor, a seventh resistor, a first operational amplifier, a second operational amplifier, and a capacitor.

15. The touch apparatus according to claim 14, wherein in the common mode voltage generation circuit, one terminal of the eleventh resistor is connected to the first input voltage and the other terminal of the eleventh resistor is connected to one terminal of the thirteenth resistor and a positive pole of the first operational amplifier in the voltage differential generation circuit, one terminal of the twelfth resistor is connected to the first input voltage and the other terminal of the twelfth resistor is connected to one terminal of the fourteenth resistor and a positive pole of the second operational amplifier in the voltage differential generation circuit, the other terminal of the thirteenth resistor and the other terminal of the fourteenth resistor are grounded, a resistance ratio of the eleventh resistor to the thirteenth resistor is N:1, and a resistance ratio of the twelfth resistor to the fourteenth resistor is 1:1; and
in the voltage differential generation circuit, a gate of the fourth PMOSFET is connected to an input signal and a gate of the fourth NMOSFET, a source of the fourth PMOSFET is connected to the first input voltage, a drain of the fourth PMOSFET is connected to one terminal of the fourth resistor and a drain of the fourth NMOSFET, a source of the fourth NMOSFET is grounded, the other terminal of the fourth resistor is connected to one terminal of the fifth resistor, one terminal of the capacitor and a negative pole of the first operational amplifier, the other terminal of the fifth resistor is connected to the other terminal of the capacitor, an output terminal of the first operational amplifier and one terminal of the sixth resistor, the other terminal of the sixth resistor is connected to a negative pole of the second operational amplifier and one terminal of the seventh resistor, the other terminal of the seventh resistor is connected to an output terminal of the second operational amplifier, the output terminal of the first operational amplifier and the output terminal of the second operational amplifier are respectively connected to two terminals of the load, a resistance ratio of the fifth resistor to the fourth resistor is N:1, a resistance of the sixth resistor is equal to that of the seventh resistor, and the fourth input voltage is 1/N of the first input voltage.

16. The touch apparatus according to claim 12, wherein the common mode voltage generation circuit is configured to, upon determining a range of the driving voltage to be generated, adjust a voltage range of an input signal based on the range of the driving voltage by a fifth voltage V₅, and adjust reference voltages of a first operational amplifier and a second operational amplifier from a sixth voltage V₆ to a seventh voltage V₇, and the fifth voltage V₅, the sixth voltage V₆, the seventh voltage V₇ satisfy the equation V₅=V₇−V₆, where the sixth voltage V₆ is a half of a maximum value of the driving voltage to be generated.

17. The touch apparatus according to claim 16, wherein the common mode voltage generation circuit comprises: an eighth resistor, a ninth resistor, a tenth resistor, a first p-channel metal-oxide-semiconductor field-effect transistor (PMOSFET), a second PMOSFET, a third PMOSFET, a first n-channel metal-oxide-semiconductor field-effect transistor (NMOSFET), a second NMOSFET, a third NMOSFET, a third operational amplifier, a fourth operational amplifier, a first buffer, and a second buffer; and
the voltage differential generation circuit comprises: a fourth resistor, a fifth resistor, a sixth resistor, a seventh resistor, a first operational amplifier, a second operational amplifier, and a capacitor.

18. The touch apparatus according to claim 17, wherein in the common mode voltage generation circuit, a gate of the first PMOSFET is connected to an input signal, a source of the first PMOSFET is connected to an output terminal of the first buffer, a drain of the first PMOSFET is connected to a drain of the first NMOSFET and one terminal of the fourth resistor in the voltage differential generation circuit, an input terminal of the first buffer is connected to a drain of the second PMOSFET and one terminal of the eighth resistor, a gate of the second PMOSFET is connected to a gate of the third PMOSFET, a drain of the third PMOSFET and a drain of the third NMOSFET, a source of the second PMOSFET is connected to a source of the third PMOSFET and a power supply, a gate of the first NMOSFET is connected to an input signal, a source of the first NMOSFET is connected to an output terminal of the second buffer, an input terminal of the second buffer is connected to a drain of the second NMOSFET and one terminal of the ninth resistor, a gate of the second NMOSFET is connected to an output terminal of a third operational amplifier, a source of the second NMOSFET is connected to one terminal of the tenth resistor and grounded, a positive pole of the third operational amplifier is connected to the other terminal of the eighth resistor and the other terminal of the ninth resistor, a negative pole of the third operational amplifier is connected to a second input voltage, the other terminal of the tenth resistor is connected to a source of the third NMOSFET and a negative pole of a fourth operational amplifier, a positive pole of the fourth operational amplifier is connected to a third input voltage, an output terminal of the fourth operational amplifier is connected to a gate of the third NMOSFET, and a resistance of the eighth resistance is equal to that of the ninth resistor; and
in the voltage differential generation circuit, the other terminal of the fourth resistor is connected to one terminal of the fifth resistor, one terminal of the capacitor is connected to a negative pole of the first operational amplifier, the other terminal of the fifth resistor is connected to the other terminal of the capacitor, an output terminal of the first operational amplifier and one terminal of the sixth resistor, the other terminal of the sixth resistor is connected to a negative pole of the second operational amplifier and one terminal of the seventh resistor, the other terminal of the seventh resistor is connected to an output terminal of the second operational amplifier, a positive pole of the first operational amplifier and a positive pole of the second operational amplifier are both connected to a second input voltage, an output terminal of the first operational amplifier and an output terminal of the second operational amplifier are respectively connected to two terminals of the load, and a resistance of the sixth resistor is equal to that of the seventh resistor.

19. The touch apparatus according to claim 12, wherein the load is a haptic motor.

20. An electronic device, comprising: a main board, a housing, and a touch apparatus, the touch apparatus comprising a touch screen and a load driving circuit, wherein the load driving circuit comprises:
a voltage differential generation circuit configured to generate a driving voltage for driving a load; and
a common mode voltage generation circuit configured to, when the voltage differential generation circuit generates the driving voltage for driving the load, adjust voltages output by a first output terminal and a second output terminal of the voltage differential generation circuit by a same voltage value.

21. The electronic device according to claim 20, wherein the common mode voltage generation circuit is configured to adjust a reference voltage of a first operation amplifier of the voltage differential generation circuit from a second voltage to a third voltage V₃, and adjust a reference voltage of a second operation amplifier of the voltage differential generation circuit from the second voltage to a fourth voltage V₄, wherein the third voltage
$${V}_{3} = \frac{{V}_{reg} + {V}_{1}}{N + 1} ,$$
and the fourth voltage
$${V}_{4} = \frac{{V}_{reg}}{2} + {V}_{1} ,$$
where V_{reg} represents a first input voltage, V₁ represents a voltage by which voltages output by the first output terminal and the second output terminal of the voltage differential generation circuit are adjusted, N represents a gain of the voltage differential generation circuit; the second voltage is a half of the first input voltage of the voltage differential generation circuit; and the first input voltage is a maximum value of the driving voltage to be generated.

22. The electronic device according to claim 21, wherein the common mode voltage generation circuit comprises: an eleventh resistor, a twelfth resistor, a thirteenth resistor, and a fourteenth resistor; and
the voltage differential generation circuit comprises: a fourth p-channel metal-oxide-semiconductor field-effect transistor (PMOSFET), a fourth n-channel metal-oxide-semiconductor field-effect transistor (NMOSFET), a fourth resistor, a fifth resistor, a sixth resistor, a seventh resistor, a first operational amplifier, a second operational amplifier, and a capacitor.

23. The electronic device according to claim 22, wherein in the common mode voltage generation circuit, one terminal of the eleventh resistor is connected to the first input voltage and the other terminal of the eleventh resistor is connected to one terminal of the thirteenth resistor and a positive pole of the first operational amplifier in the voltage differential generation circuit, one terminal of the twelfth resistor is connected to the first input voltage and the other terminal of the twelfth resistor is connected to one terminal of the fourteenth resistor and a positive pole of the second operational amplifier in the voltage differential generation circuit, the other terminal of the thirteenth resistor and the other terminal of the fourteenth resistor are grounded, a resistance ratio of the eleventh resistor to the thirteenth resistor is N:1, and a resistance ratio of the twelfth resistor to the fourteenth resistor is 1:1; and
in the voltage differential generation circuit, a gate of the fourth PMOSFET is connected to an input signal and a gate of the fourth NMOSFET, a source of the fourth PMOSFET is connected to the first input voltage, a drain of the fourth PMOSFET is connected to one terminal of the fourth resistor and a drain of the fourth NMOSFET, a source of the fourth NMOSFET is grounded, the other terminal of the fourth resistor is connected to one terminal of the fifth resistor, one terminal of the capacitor and a negative pole of the first operational amplifier, the other terminal of the fifth resistor is connected to the other terminal of the capacitor, an output terminal of the first operational amplifier and one terminal of the sixth resistor, the other terminal of the sixth resistor is connected to a negative pole of the second operational amplifier and one terminal of the seventh resistor, the other terminal of the seventh resistor is connected to an output terminal of the second operational amplifier, the output terminal of the first operational amplifier and the output terminal of the second operational amplifier are respectively connected to two terminals of the load, a resistance ratio of the fifth resistor to the fourth resistor is N:1, a resistance of the sixth resistor is equal to that of the seventh resistor, and the fourth input voltage is 1/N of the first input voltage.

24. The electronic device according to claim 20, wherein the common mode voltage generation circuit is configured to, upon determining a range of the driving voltage to be generated, adjust a voltage range of an input signal based on the range of the driving voltage by a fifth voltage V₅, and adjust reference voltages of a first operational amplifier and a second operational amplifier from a sixth voltage V₆ to a seventh voltage V₇, and the fifth voltage V₅, the sixth voltage V₆, the seventh voltage V, satisfy the equation V ₅=V₇−V₆, where the sixth voltage V₆ is a half of a maximum value of the driving voltage to be generated.

25. The electronic device according to claim 24, wherein the common mode voltage generation circuit comprises: an eighth resistor, a ninth resistor, a tenth resistor, a first p-channel metal-oxide-semiconductor field-effect transistor (PMOSFET), a second PMOSFET, a third PMOSFET, a first n-channel metal-oxide-semiconductor field-effect transistor (NMOSFET), a second NMOSFET, a third NMOSFET, a third operational amplifier, a fourth operational amplifier, a first buffer, and a second buffer; and
the voltage differential generation circuit comprises: a fourth resistor, a fifth resistor, a sixth resistor, a seventh resistor, a first operational amplifier, a second operational amplifier, and a capacitor.

26. The electronic device according to claim 25, wherein in the common mode voltage generation circuit, a gate of the first PMOSFET is connected to an input signal, a source of the first PMOSFET is connected to an output terminal of the first buffer, a drain of the first PMOSFET is connected to a drain of the first NMOSFET and one terminal of the fourth resistor in the voltage differential generation circuit, an input terminal of the first buffer is connected to a drain of the second PMOSFET and one terminal of the eighth resistor, a gate of the second PMOSFET is connected to a gate of the third PMOSFET, a drain of the third PMOSFET and a drain of the third NMOSFET, a source of the second PMOSFET is connected to a source of the third PMOSFET and a power supply, a gate of the first NMOSFET is connected to an input signal, a source of the first NMOSFET is connected to an output terminal of the second buffer, an input terminal of the second buffer is connected to a drain of the second NMOSFET and one terminal of the ninth resistor, a gate of the second NMOSFET is connected to an output terminal of a third operational amplifier, a source of the second NMOSFET is connected to one terminal of the tenth resistor and grounded, a positive pole of the third operational amplifier is connected to the other terminal of the eighth resistor and the other terminal of the ninth resistor, a negative pole of the third operational amplifier is connected to a second input voltage, the other terminal of the tenth resistor is connected to a source of the third NMOSFET and a negative pole of a fourth operational amplifier, a positive pole of the fourth operational amplifier is connected to a third input voltage, an output terminal of the fourth operational amplifier is connected to a gate of the third NMOSFET, and a resistance of the eighth resistance is equal to that of the ninth resistor; and
in the voltage differential generation circuit, the other terminal of the fourth resistor is connected to one terminal of the fifth resistor, one terminal of the capacitor is connected to a negative pole of the first operational amplifier, the other terminal of the fifth resistor is connected to the other terminal of the capacitor, an output terminal of the first operational amplifier and one terminal of the sixth resistor, the other terminal of the sixth resistor is connected to a negative pole of the second operational amplifier and one terminal of the seventh resistor, the other terminal of the seventh resistor is connected to an output terminal of the second operational amplifier, a positive pole of the first operational amplifier and a positive pole of the second operational amplifier are both connected to a second input voltage, an output terminal of the first operational amplifier and an output terminal of the second operational amplifier are respectively connected to two terminals of the load, and a resistance of the sixth resistor is equal to that of the seventh resistor.

27. The electronic device according to claim 20, wherein the load is a haptic motor.
